(19) United States
(12) Patent Application Publication
(10) Pub. No.: US 2003/0076282 A1
(43) Pub. Date: Apr. 24, 2003

(54) Display device and method for driving the same

(75) Inventors: Takayuki Ikeda, Kanagawa (JP); Kiyoshi Kato, Kanagawa (JP); Yoshimoto Kurokawa, Kanagawa (JP)

Correspondence Address: NIXON PEABODY, LLP, 8180 GREENSBORO DRIVE, SUITE 800, MCLEAN, VA, 22102, US

(73) Assignee: SEMICONDUCTOR ENERGY LABORATORY CO., LTD., Kanagawa-ken (JP)

(21) Appl. No.: 10/272,977

(22) Filed: Oct. 18, 2002

(30) Foreign Application Priority Data
Oct. 19, 2001 (JP) 2001-321912

(51) Int. Cl. G09G 3/20

(52) U.S. Cl. 345/55

(57) ABSTRACT

According to a display device of the present invention, a frame memory is integrally formed on a substrate (pixel substrate) on which a pixel portion is formed. With this construction, one row of data can be simultaneously read from the frame memory and can be input to a drive circuit for pixels in parallel. As a result, a need for transferring image data in serial is eliminated. Then, a parallel/serial converting circuit and a serial output circuit, and a serial/parallel converting circuit and a parallel input circuit are not necessary. Therefore, a display device having a frame memory and a pixel portion can be constructed in a simpler construction and with an easier circuit. As a result, the noise can be reduced, and the low power consumption can be achieved.

### BACKGROUND OF THE INVENTION

1. Filed of the Invention

The present invention relates to a display device having a plurality of pixels on an insulation film thereof. Further, it relates to electronic apparatuses utilizing the foregoing display device.

2. Description of the Related Arts

In recent years, as a flat display, field effect type display devices using electron source elements such as liquid crystal display devices using liquid crystal display elements, OLED (organic light emitting diode) devices using OLED elements, FE (field emission display) type, MIM (Metal-Insulator-Metal) type and the like come under the spotlight.

These display devices are manufactured in low cost by virtue of using thin film transistors (hereafter referred to as TFTs) to form pixels on the insulation film.

The configuration of display devices in the prior art is described as below.

FIG. 4 is a block diagram showing the configuration of display devices in the prior art.

In FIG. 4, a display device comprises a pixel substrate 1000 formed by a pixel portion 1001 having a plurality of pixels and a latch circuit 1007, and an external substrate 1002 formed by a frame memory 1003.

At this time, the substrate formed by the pixel portion 1001 and the substrate formed by the frame memory 1003 are separate substrates.

In a display device having the above structure, in order to transfer the signals stored in the frame memory formed on the external substrate to the pixel substrate 1000, a cable 1005 for connecting the pixel substrate 1000 with the external substrate is required. In case of using the cable 1005, although it depends on an image data, but usually, using a cable to transfer one line date of the image by parallel is hard to be done, as a result, the image date from the frame memory 1003 is transferred by serial.

Therefore, a serial/parallel conversion circuit 1006 is formed on the pixel substrate 1000 to convert serial signals to parallel signals. Meanwhile, a parallel/serial conversion circuit 1004 is formed on the external substrate 1002 to convert parallel signals to serial signals.

In a conventional display device as shown in FIG. 4, parallel image data stored in a frame memory must be input as serial signals to a pixel substrate and must be converted to parallel signals again.

Therefore, there is a problem that the speed for transferring signals from the frame memory to a pixel portion is limited and, as a result, the image displaying speed is slow.

Also, there is a problem that the effect of noise is large because signals are transferred from the frame memory to the pixel portion by using a long wiring.

In addition, the external substrate requires a parallel/serial converting circuit and a serial output circuit. Furthermore, the pixel substrate requires serial/parallel converting circuit and/or a parallel input circuit. As a result, the circuit becomes more complicated, and the power consumption is large.

### SUMMARY OF THE INVENTION

In order to overcome the above-problems, it is an object of the present invention to provide a display device, which has the higher reading speed from a memory and low signal noise effects and which can be reduced in size.

In order to achieve the object, following measures are taken in the present invention.

A conventional frame memory is generally formed on single crystal silicon and is implemented on an external substrate. However, according to the invention, the frame memory is integrally formed on a substrate (pixel substrate) in which a pixel portion is formed.

According to one aspect of the present invention, there is provided a display device including a plurality of pixels formed by using a thin film transistor on an insulating surface, a memory having a plurality of memory cells, and a drive circuit having a source driver and a gate driver, wherein serial signal data input externally is output in parallel to the plurality of pixels by using a plurality of wirings through the memory. In this case, the serial signal data input externally may be not only those input from the outside of a pixel substrate but also those input from a CPU formed on the pixel substrate.

According to another aspect of the present invention, there is provided a display device including a plurality of pixels formed by using a thin film transistor on an insulating surface, a memory having a plurality of memory cells, and a drive circuit having a source driver and a gate driver, wherein the drive circuit is formed on the insulating surface for simultaneously reading out digital signals stored in the plurality of memory cells, respectively, and for inputting to the plurality of pixels through a plurality of wirings formed on the insulating surface.

In this case, the display device may have a unit for holding the output digital signals, a unit for inputting the held digital signals to the plurality of pixels simultaneously, or a unit for holding the output digital signals and a unit for converting the held digital signals to analog signals and for inputting to the plurality of pixels simultaneously.

In this case, the simultaneously input may be the data for one row or one column of pixels or may be a section of one row or one column of the plurality of pixels, which are divided into a plurality of parts.

In this case, the memory must have a capacity, which can store digital signals for at least several rows of pixels and may be an SRAM or DRAM.

In this case, an element used as a pixel may be any of a liquid crystal display device, an OLED or an electron source element. The thin film transistor used in the device may be formed either of a polycrystal susconductor thin film and amorphous subconductor thin film.

According to another aspect of the present invention, there is provided a method of driving a display device including a plurality of pixels formed by using a thin film transistor on an insulating surface, a memory having a plurality of memory cells, and a drive circuit having a source driver and a gate driver, wherein serial signal data input externally is output in parallel to the plurality of pixels by using a plurality of wirings through the memory.

According to another aspect of the present invention, there is provided a method of driving a display device including a plurality of pixels formed by using a thin film transistor on an insulating surface, a memory having a plurality of memory cells, and a drive circuit having a source driver and a gate driver, wherein data stored in the plurality of memory cells are read out as digital signals simultaneously and are input to the plurality of pixels simultaneously.

In this case, the method may include the steps of reading out data stored in one row of the plurality of memory cells as digital signals, holding the digital signals, and simultaneously inputting to the plurality of pixels.

In this case, the held digital signals may be converted, to be input to plurality of pixels simultaneously.

In this case, the pixel to be input simultaneously may be one row of pixels or may be a section of one row, which is divided into a plurality of parts.

With this construction one row can be read out from the frame memory and can be parallel-input to the pixel drive circuit. As a result, image data does not have to be serial-transferred. In addition, circuits such as a parallel/serial converting circuit, serial output circuit, a serial/parallel converting circuit and parallel input circuit are not required.

In this way, a display device having a frame memory and a pixel portion can be constructed by using simpler configuration and easier circuits. As a result, the noise reduction can be achieved, and the power consumption can be reduced.

The speed of transferring image data when parallel-processing all of image data for one row of the frame memory is significantly increased in comparison with the serial transfer. As a result, the image display can be performed much faster, and the image quality can be improved.

Furthermore, since the frame memory is constructed by using a TFT (or capacitance or resistance) similar to the pixel portion, the production of the frame memory can be performed without changing the process for forming the pixel portion very much. When a frame memory is integrally formed, the cost can be reduced in comparison with a case where a separate chip is implemented.

Conventionally, when a frame memory is produced on a pixel substrate, the operational speed of the memory is slower than that of the memory on single crystal silicon. The memory cell is also large. However, these difficulties can be reduced or be avoided as described below.

First of all, regarding the operational speed of the memory, a TFT having higher mobility can be obtained than a TFT formed on a substrate having a conventional insulating surface, by using a process described in embodiments herein. Thus, a memory, which is practical as a frame memory in the operational speed, can be formed.

Even other polysilicon and/or amorphous silicon can be used without considering the demerit of the operational speed, depending on the number of pixels, a display method, a construction of a frame memory and an image content.

The size of an entire memory can be reduced in comparison with an increase in size due to the use of a separate external substrate. Even in comparison with a case where a memory is implemented by using COG technology, the memory size is not problematic in view of margins required for the implementation. Furthermore, the microfabrication of TFT's is evolving, and an advantageous arrangement for the size reduction can be expected in the future.

In the present invention, a frame memory is a memory for storing video signals input from the outside of a display device for one frame or for several frames. The video signals for one frame once stored in the frame memory are read out in an arbitrary order depending on a display method.

### BRIEF DESCRIPTION OF THE DRAWINGS

FIG. 1 is a schematic view in accordance with the present invention;

FIG. 2 is a diagram showing the Embodiment of the present invention;

FIG. 3 illustrates a block diagram 1 showing the configuration of the present invention;

FIG. 4 is a block diagram showing the configuration of display devices in the prior art;

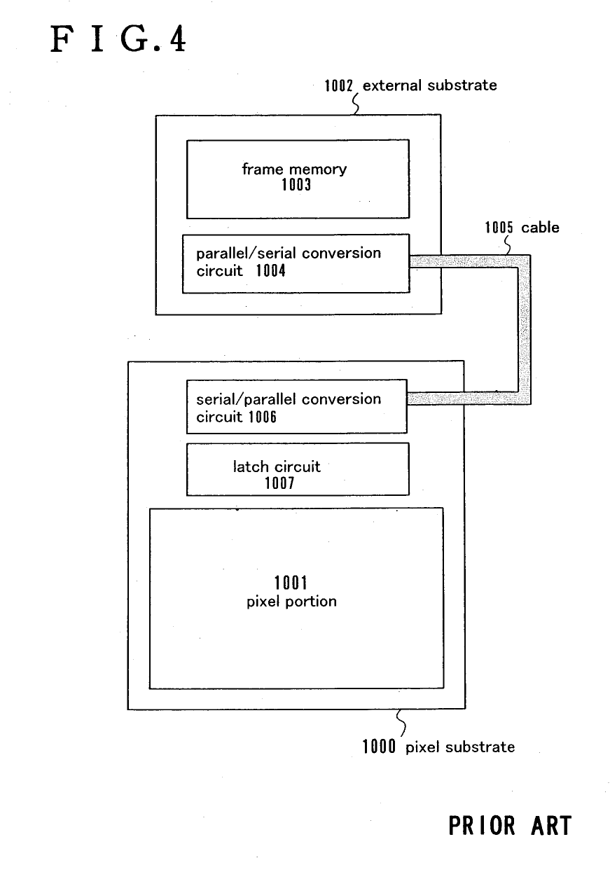

FIG. 5 is a diagram illustrating the structure of a frame memory;

FIG. 6 shows a circuit diagram of a memory cell;

FIG. 7 shows a circuit diagram of a sense amplifier;

FIG. 8 is an arrangement plan of a latch;

FIG. 9 is a circuit diagram of a latch;

FIG. 10 shows a circuit diagram of a level shifter;

FIG. 11 shows a circuit diagram of a DAC;

FIG. 12 shows a circuit diagram of a voltage control switch;

FIG. 13 is a diagram showing the structure of a pixel;

FIG. 14 is a circuit diagram of a pixel unit;

FIGS. 15A-C are cross-sectional views 1 of a liquid crystal display portion and a driver circuit in formation process;

FIGS. 16A-C are cross-sectional views 2 of a liquid crystal display portion and a driver circuit in formation process;

FIG. 17A and FIG. 17B are cross-sectional views 3 of a liquid crystal display portion and a driver circuit in formation process;

FIG. 18A and FIG. 18B are cross-sectional views 4 of a liquid crystal display portion and a driver circuit in formation process;

FIG. 19 is a diagram showing the structure of a frame memory of a liquid crystal display device in another embodiment of the present invention;

FIG. 20 shows a diagram of the structure of a pixel portion;

FIG. 21 is a cross-sectional view of a display device using MIM type electron source element;

FIGS. 22A-C are cross-sectional views 1 of a display portion and a driver circuit using OLEDs in formation process;

FIGS. 23A-C are cross-sectional views 2 of a display portion and a driver circuit using OLEDs in formation process;

FIG. 24A and FIG. 24B are cross-sectional views 3 of a display portion and a driver circuit using OLEDs in formation process;

FIG. 25 is a block diagram 2 showing the configuration of the present invention;

FIG. 26 is a block diagram 3 showing the configuration of the present invention;

FIG. 27 is a block diagram 4 showing the configuration of the present invention.

### DESCRIPTION OF THE PREFERRED EMBODIMENTS

[Embodiment Mode]

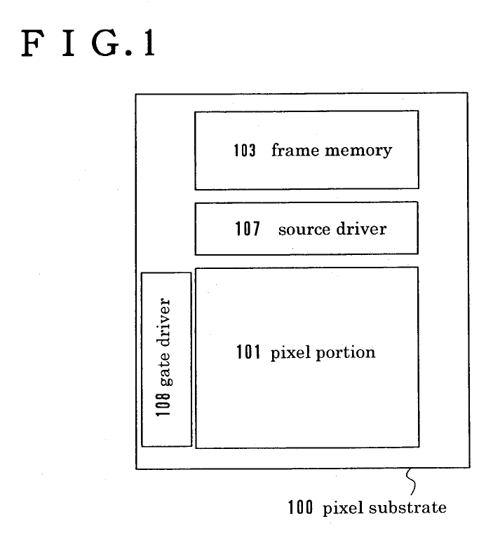

FIG. 1 shows a block diagram showing a typical construction of a display device according to the present invention.

In FIG. 1, a frame memory 103 and a drive circuit are integrally formed on a pixel substrate 100 having an insulating surface on which a pixel portion 101 is formed. The drive circuit is divided into a source driver 107 and a gate driver 108 depending on the functions hereinafter. Signals input externally are once stored in the frame memory 103 and then are read out. Then, the read signals are output to multiple pixels of the pixel portion 101 by using multiple wirings through the source driver 107 at the same time. By using signals generated from the external signals, the gate driver 108 performs display control on each of pixels in the pixel portion 101.

The frame memory 103 has multiple memory cells arranged in matrix.

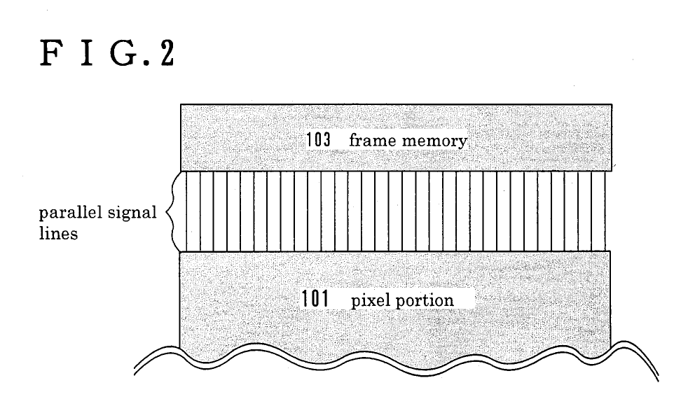

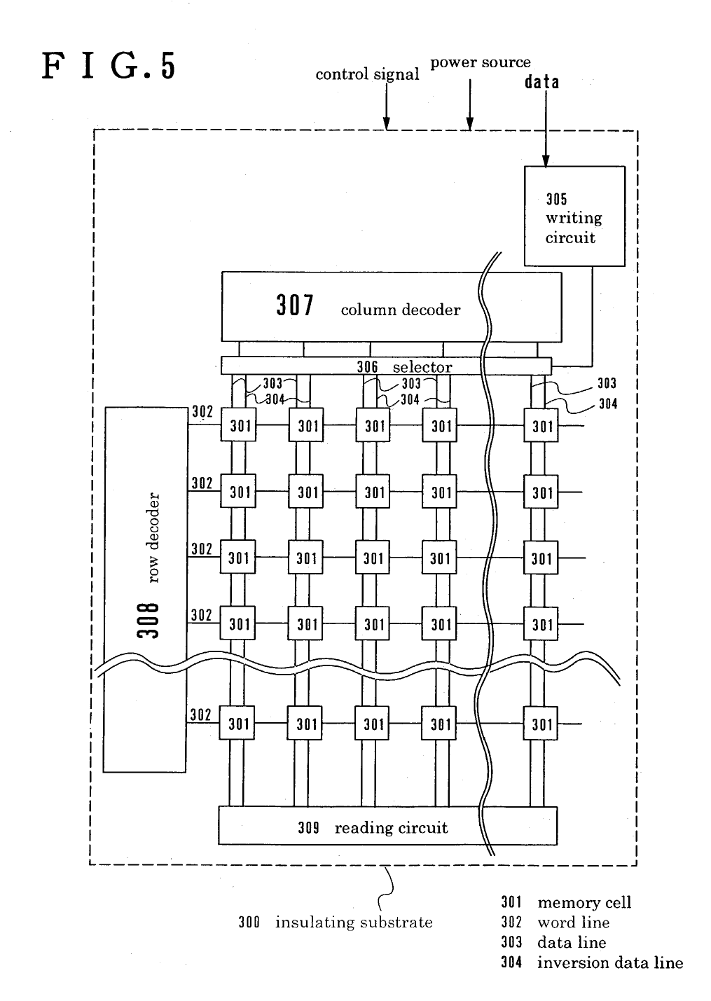

FIG. 2 shows an example of this embodiment mode where the frame memory 103 and pixels are connected in parallel through signal lines whose number is equal to the number of data for one row of pixels. In the structure of the frame memory 103, many memory cells 301 are arranged in matrix as shown in FIG. 5. Here, signals externally input in series can be output to the pixel portion 101 at the same time through signal lines connected in parallel.

The frame memory shown in this embodiment mode includes an SRAM. A word line 302, a data line 303 and an inversion data line 304 are connected to each of the memory cells 301. A memory cell is selected by a row decoder 308 and a column decoder 307. The row decoder 308 selects one of the multiple word lines 302. The column decoder 307 selects the data line 303 and the inversion data line 304 connected to the selected memory cell 301 through a selector 306. Then, signals from a writing circuit 305 are written in the memory cells 301, or signals written in the memory cells 301 are read by a parallel reading circuit 309. They are formed on the same insulating substrate 300. Data, an address signal, a control signal such as a reading signal and power to the frame memory are supplied externally.

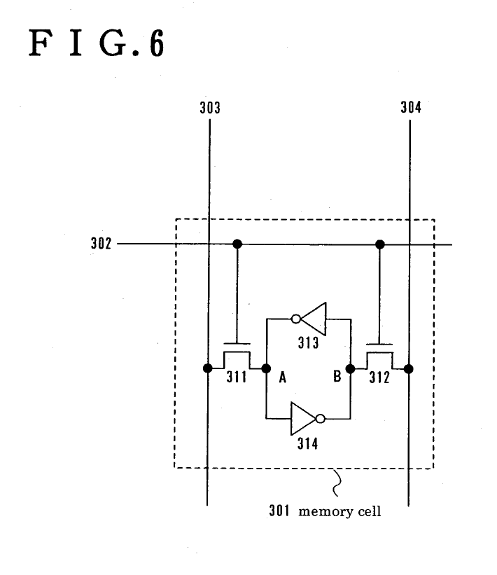

The memory cell includes a first transistor 311, a second transistor 312, a first inverter 313, and a second inverter 314 as shown in FIG. 6. In each of the memory cells, the word line 302 is connected to gate electrodes of the first transistor 311 and the second transistor 312, the data line 303 is connected to a source electrode or a drain electrode of the first transistor 311 and the inversion data line 304 is connected to a source electrode or a drain electrode of the second transistor 312, respectively.

The first inverter 313 and the second inverter 314 have flip-flop structures where the output of the first inverter 313 is connected to the input of the second inverter 314 and, similarly, the output of the second inverter 314 is connected to the input of the first inverter 313.

Then, the first transistor (sometimes called select transistor, hereinafter) 311 is connected to the data-line through the source or drain electrode. The second transistor 312 is connected to the inversion data line through the source or drain electrode. The gate electrode is connected to the word line.

An operational principle of the memory cell in FIGS. 5 and 6 will be described. First of all, when the select transistors 311 and 312 are at the ON state suppose that, “1” is supplied to the data line and “0” is supplied to the inversion data line, for example. Then, “1” and “0” are written in the point A and the point B, respectively, in the flip-flop manner. Even when the select transistors 311 and 312 are at the OFF state, the condition is continuously maintained. Then, when the select transistors 311 and 312 are returned to the “ON” state, “1” and “0” are read to the data line and the inversion data line, respectively.

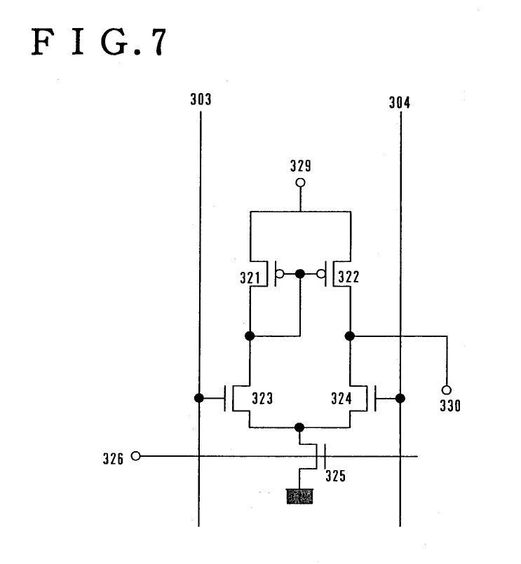

A sense amplifier will be described as an example of the circuit 309 for reading signals from the memory cell. An example of the structure of the sense amplifier is shown in FIG. 7. Here, circuits corresponding to one data line and one inversion data line are shown typically.

As shown in FIG. 7, the sense amplifier includes five transistors 321 to 325. When a power source VDD 329 and a bias potential 326 are applied thereto, High or Low signal 330 is output in accordance with the sizes of the potentials of the data line 303 and the inversion data line 304. A constant current source can be used instead of the transistor 325. One or multiple inverters may be given to the output 330 as necessary.

Digital signals stored in the multiple memory cells are read out in parallel by using the reading circuit, are transferred to the source driver 107 by keeping them as parallel signals, and are output to the pixel portion at the same time. The signals may be held by constructing a latch circuit within the source driver 107, signals can be held. By constructing a DAC within the source driver 107 similarly, the digital signals may be converted to analog signals which are transferred to the pixel portion.

The frame memory may be an SRAM or a DRAM. Furthermore, a memory having any of publicly known construction can be used which can be produced on the insulating surface.

The data simultaneously sent out from the frame memory does not have to be data for one row of pixels and may be data for less than one row of pixels. For example, in the case of the RGB color display, data output from the frame memory may be only data input to any of R, G ad B among pixels in one row. In this case, one frame or one horizontal period may be divided into three, which can be displayed in three times for R, G and B, respectively. Naturally, data output within one frame is not limited to the RGB division and may be one of several divisions of data in one row of pixels.

The gate driver 108 sends out generated signals to each pixel in the pixel portion 101 by externally inputting a start pulse and a clock. By inverting the positional relationship of the source driver 107 and the gate driver 108, signals can be input to not only one row of pixels but also one column of pixels or the part thereof simultaneously.

Those used as the pixels may be liquid crystal, OLED, electron source elements. The detail of the embodiment using them will be described later. The present invention can be applied to the other pixels having publicly known constructions.

The transistor used in the pixel, the memory cell and the drive circuit can be formed by TFT. The TFT can be produced by an amorphous semiconductor or a polycrystal semiconductor. The production process will be described later.

### EMBODIMENTS

Embodiments of the present invention will be described.

(Embodiment 1)

This embodiment describes a construction of a display in which device digital video signals are stored in a memory, and analog-converted and input to a pixel portion.

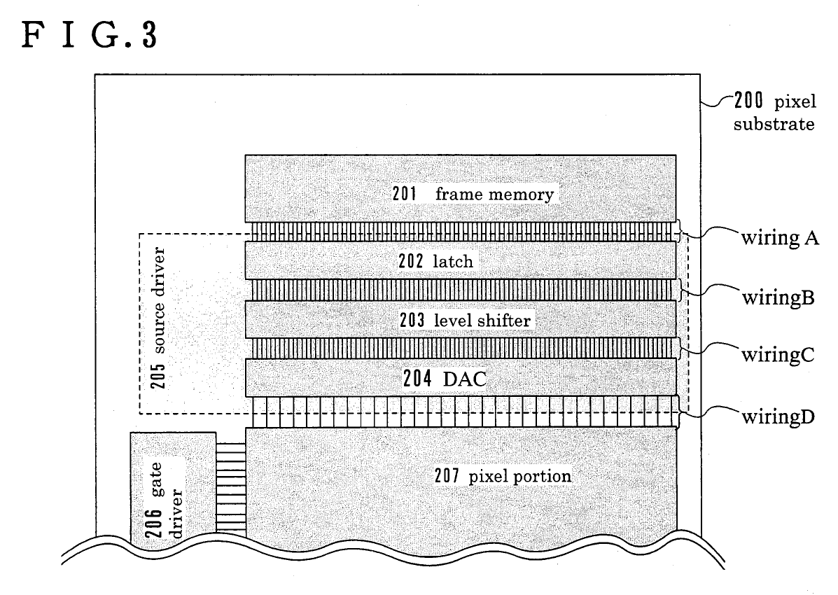

FIG. 3 is a block diagram showing a construction of this embodiment.

In FIG. 3, a display device has a frame memory 201, a source driver 205, a gate driver 206 and a pixel portion 207, which are formed on a pixel substrate 200 having an insulating surface. In the frame memory 201, digital video signals input from the outside of the display device are stored.

Here, the number of wirings A to C is equal to the number of pixels×bits for one row in the case of RGB color. The number of wirings D is equal to the number of pixels for one row. That is, in this case, image data for one row can be sent out simultaneously.

As described in the embodiment, data for one row of pixel does not have to be stored in one row of frame memory and may be data for one row of pixels or below. In that case, only providing a selector between the DAC and the pixels for selecting a pixel is enough in the block construction of the source driver shown in FIG. 3. The selector may be one publicly known.

For example, in the case of RGB color display, any of R, G ad B among pixels for one row may be in one row of frame memory. In this case, one frame or one horizontal period may be divided into three, which can be displayed in three times for R, G and B, respectively. Then, a selector for selecting RGB pixels may be provided between the DAC and the pixels.

The frame memory 201 among those shown in FIG. 3 has been described above. The source driver 205, the gate driver 206, and the pixel portion 207 will be described below in detail.

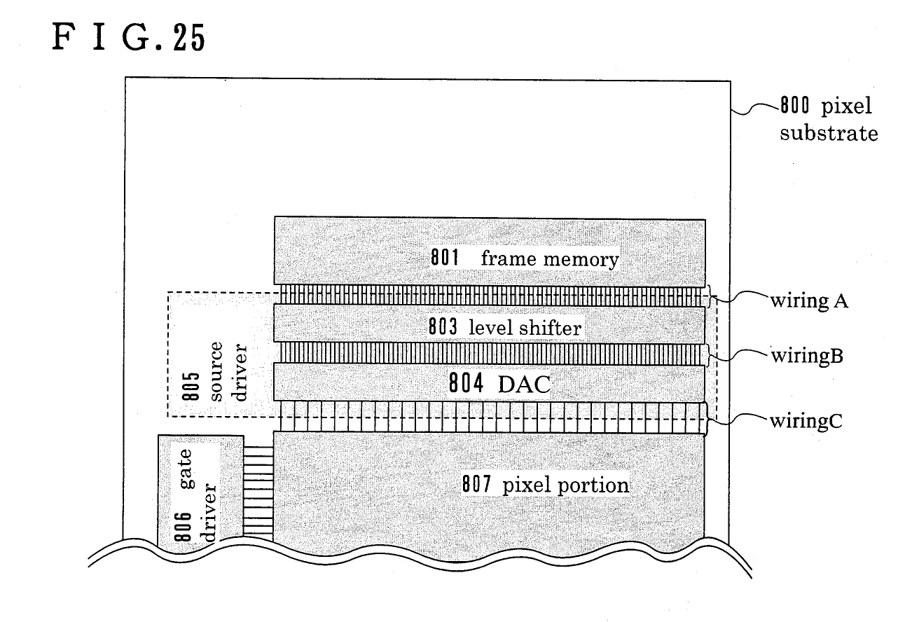

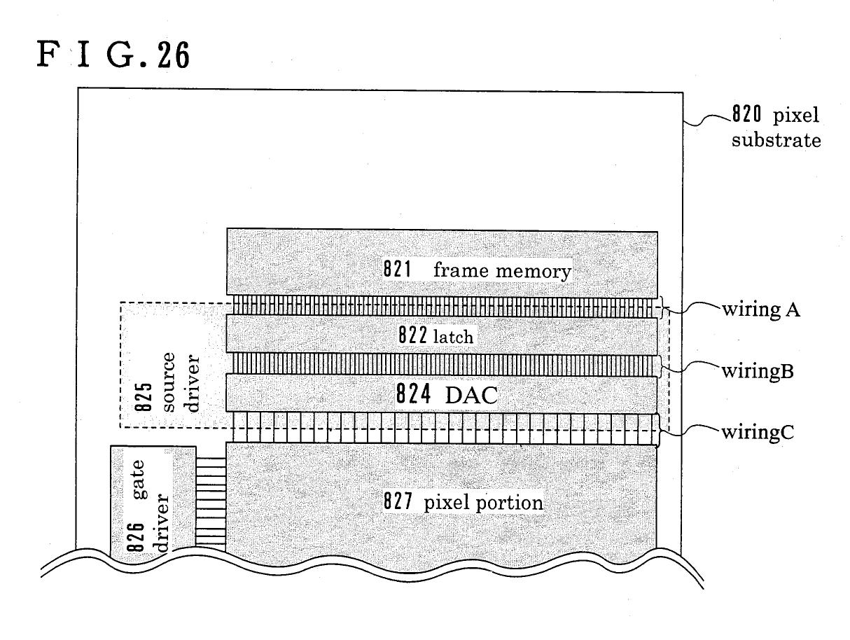

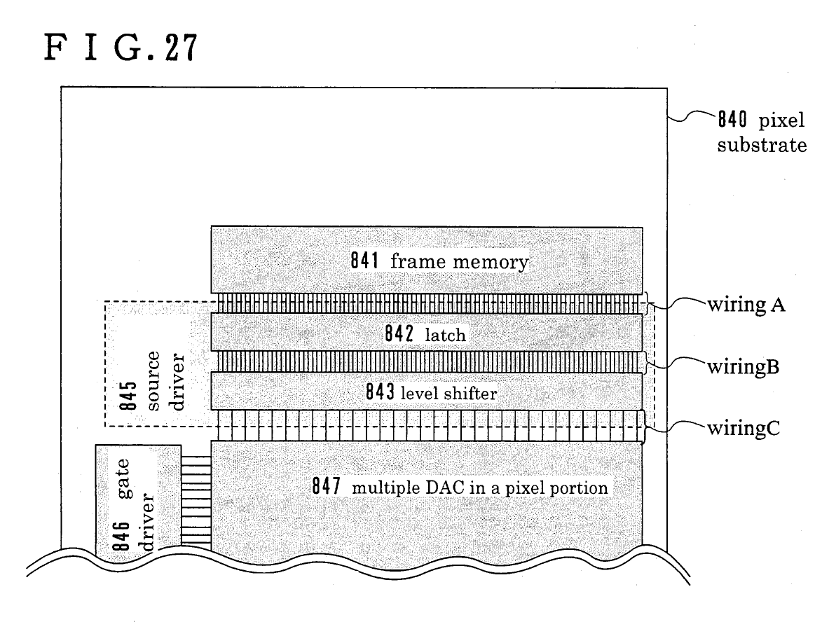

The source driver 205 includes a latch 202, a level shifter 203, and a digital/analog converter (written as DAC hereinafter) 204. However, though this construction is shown in FIG. 3, the source driver 805 may include a level shifter 803 and a DAC 804 as shown in FIG. 25. By providing the function of the level shifter 203 to the DAC 204, a source driver 825 can include a latch 822 and a DAC 824 as shown in FIG. 26. Furthermore, a construction as shown in FIG. 27 is possible including multiple DAC in a pixel portion 847 in order to directly transmit the parallel signal to the pixel portion. Naturally, the latche, level shifter and DAC herein are provided in a plural numbers, respectively.

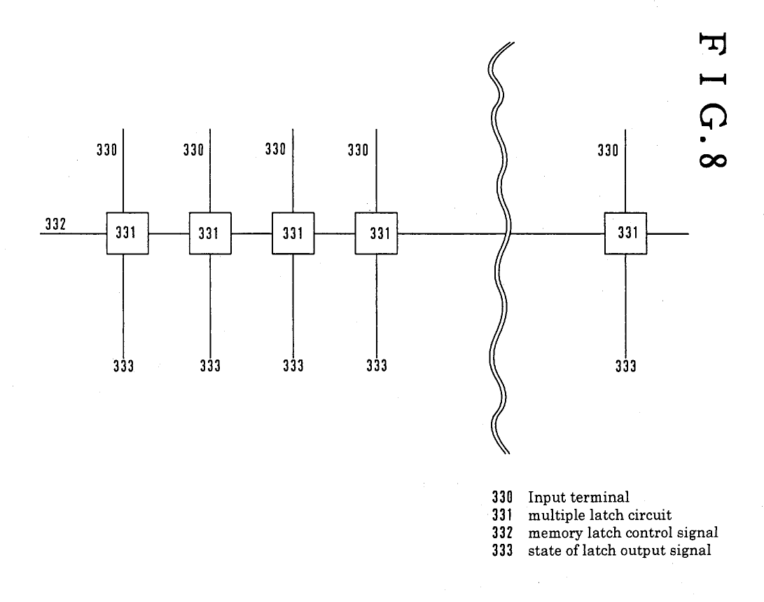

A construction of the latch 202 is shown in FIG. 8. Input terminals 330 of the multiple latch circuits 331, which are arranged in parallel, are connected to data output terminal of the sense amplifier in the frame memory 201 shown in FIG. 7. The signals output from the sense amplifier are latched all together by the latch control signal 332.

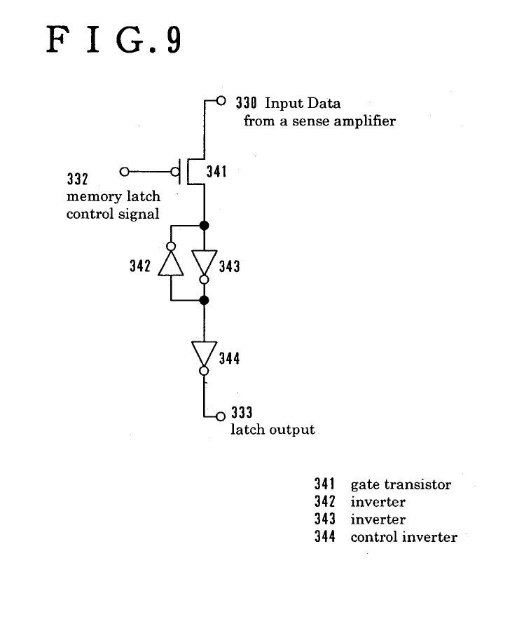

FIG. 9 shows an example of the latch circuit 331 including two inverters 342 and 343, one gate transistor 341 and a control inverter 344. Input Data 330 from a sense amplifier is output by opening the gate transistor only when the memory latch control signal 332 is “1”, by driving the inverter and by changing the state of the latch output 333. When the memory latch control signal 332 is “0”, the state of the output 333 is not changed, and the data is held.

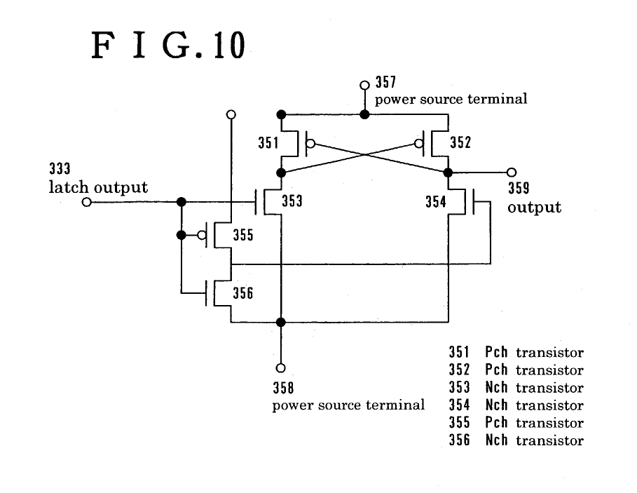

FIG. 10 shows an example of the level shifter 203. The level shifter includes six transistors 351 to 356. Input signals 333 from the latch are input to four transistors 351 to 354 along with an invert signal by an inverter including the transistors 355 and 356. The output 359 is shifted to a voltage level of a power source terminal 357 or the power source terminal 358.

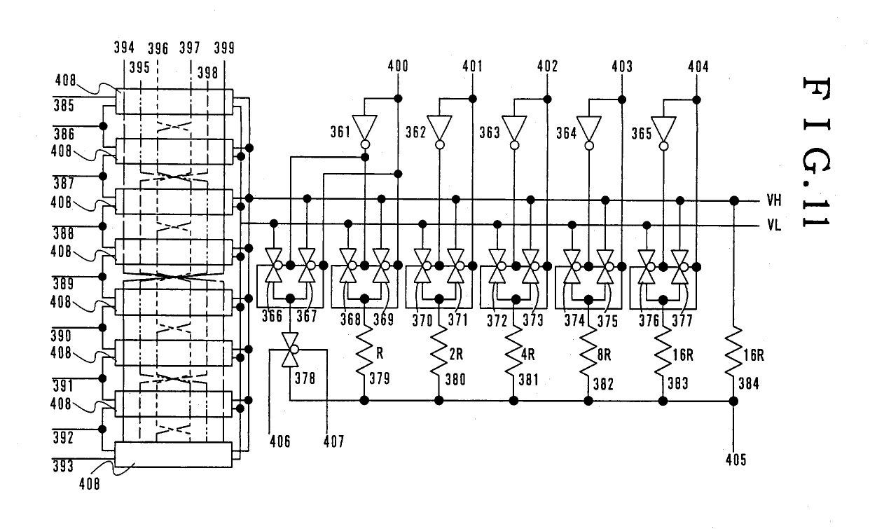

FIG. 11 shows an example of the DAC 204 in FIG. 3. The DAC in FIG. 11 converts 8-bit digital signals to analog signals and mainly includes a coarse adjustment voltage selecting portion and a fine adjustment voltage selecting portion. As shown in FIG. 11, the DAC may have a polarity inverting circuit.

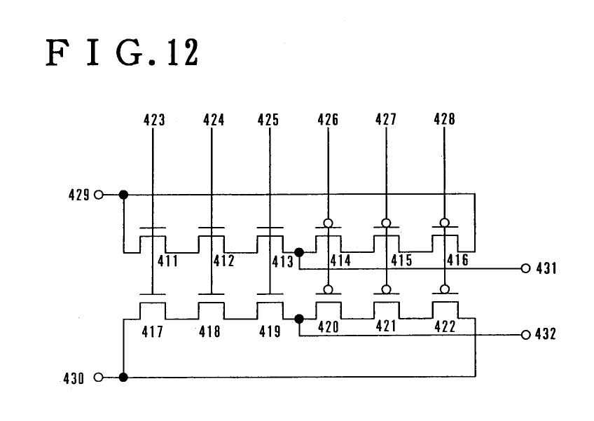

The coarse adjustment selecting portion includes eight voltage select switches 408. The voltage select switches 408 only operate for signal inputs in a certain pattern by using a transistor like the construction in FIG. 12. Thus, applied potentials 429 and 430 are output to the output potentials 431 and 432, respectively. By using this, any one of voltage select switches operates based on the input signals 394 to 396 and the inverted signals 397 to 399, which are higher three bits of the 8 bit digital signals. Thus, potentials VH and VL are generated in accordance with the input potentials 385 to 393.

In the fine adjustment voltage selecting portion, current flows to different resistances 379 to 384 in accordance with input signals 400 to 404 for the lower five bits. Thus, the potentials, VL and VH can be output from the output 405 in 32 levels of height. The output is a source line of the pixel portion. The analog switch 378 is closed during a reset period by a control signal 406 and an inverted control signal 407. The analog switch 378 is opened in the other period. While, the resistances 379 to 384 are used in FIG. 11, capacitances may be used instead of the resistances.

The gate driver 206 sends out signal generated by externally inputting a start pulse and a clock to the pixel portion through the gate line.

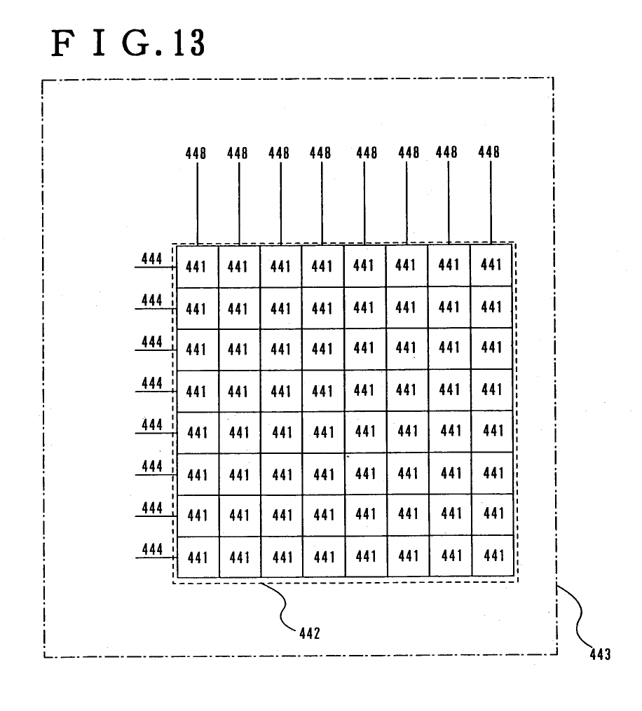

The liquid crystal display device, which is used as an example of the image display device of this embodiment, can be applied to an active-matrix type liquid crystal display device. As shown in FIG. 13, the liquid crystal display device has a pixel array 442 in which multiple pixels 441 are arranged in m×n matrix.

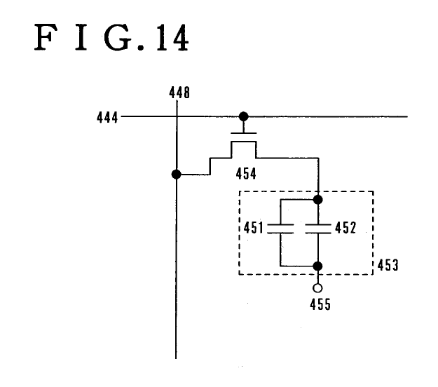

As shown in FIG. 14, each pixel includes a pixel capacitance 453 having a liquid crystal capacitance 451 and a retention capacitance 452 and a transistor 454 having a semiconductor layer of amorphous or polycrystal silicon.

The pixels 441 are formed on a light-transmission type insulting substrate 443 such as a glass substrate. Source lines 448 and gate lines 444 for driving the pixels 441 are also formed on the insulating substrate 443. Each of the pixels 441 is located at a position where each of the source lines 448 and each of the gate lines 444 overlap.

As shown in FIG. 13, each of the gate lines 444 and each of the source lines 448 are connected to each of the pixels 441 in the pixel array 442.

These wirings, the frame memory 201, the source driver 205, and the gate driver 206 can be produced in a common process mostly. Thus, they can be formed integrally on the insulating substrate 443. According to the present invention, an address signal and a read signal to the frame memory and a latch signal, a start pulse, a clock and so on to the driver are input, externally. However, a control circuit for generating these control signals from simpler external signals can be produced on the same substrate.

Depending on the capacity or construction of the frame memory, a period of rewriting the frame memory is as follows: When the frame memory has a data capacity for one image, data is rewritten during a vertical blanking period in one frame. When the frame memory has a data capacity of two images or more, data not in the memory area for displaying an image in each frame can be rewritten freely, which can provide an enough rewriting time.

If it is a memory having dual ports, which allows reading and writing at the same time by using separate data lines, image data even be in displayed can be rewritten freely. Especially, the memory has a capacity for one image or below, an image can be displayed by updating data in a memory area, which has finished to display thereof.

Here, a data capacity is expressed by:

Data capacity=number of pixels×number of tones×number of colors

The number of colors is 3 in RGB color and 1 in monochrome color and black and white. The number of tones is expressed by the number of bits so that 8 in 256 tones, 6 in 64 tones and 3 in 8 tones.

A serial/parallel converting circuit is not required to use by forming all of multiple DAC integrally on the same insulating substrate 443. Thus, the noise effects due to the improvement in speed and signals passing through the serial/parallel converting circuit can be prevented. In addition, the circuit can be simplified, and the cost can be reduced.

(Embodiment 2)

In this embodiment, processes of a formation of a structure shown in the first embodiment, in which a display portion, a driver circuit and a memory cell are formed in one body is explained below. Note that the driver circuit portion and the memory cell portion are referred to as a CMOS circuit that is a basic unit thereof.

Further, transistors that compose pixels are referred as to a transistor 454 shown in FIG. 14.

As for the pixels, only a TFT for writing, a source signal, and a storage capacitor are shown.

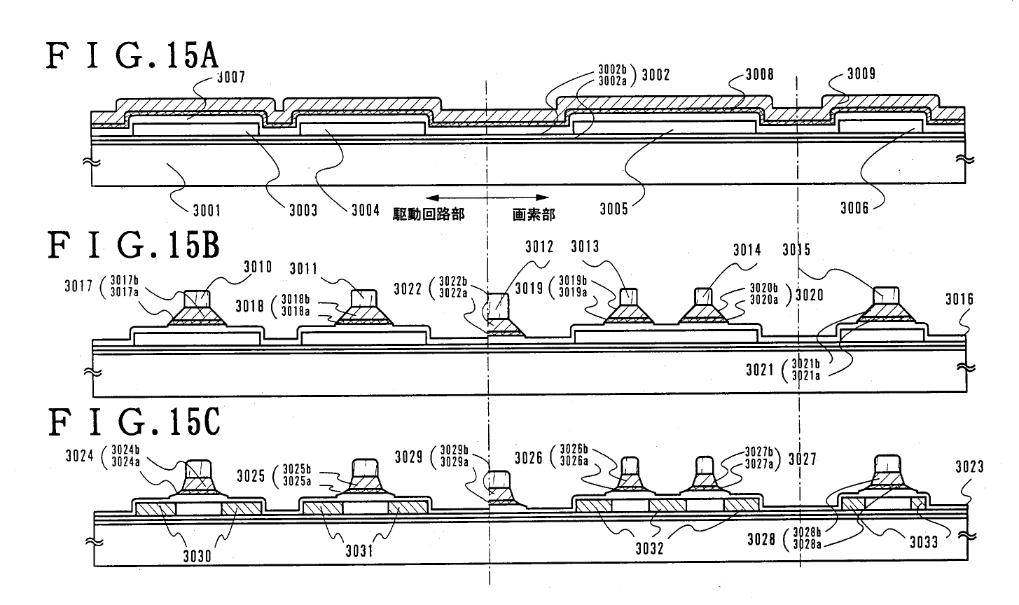

First, as shown in FIG. 15A, a base film 3002 consisting of an insulating film such as a silicon oxide film, a silicon nitride film or a silicon oxynitride film is formed on a substrate 3001 consisting of glass such as barium borosilicate glass or alumino borosilicate glass represented by #7059 glass and #1737 glass of Coning Corporation. For example, a silicon oxynitride film 3002a formed from SiH₄, NH₃ and N₂O by the plasma CVD method and having a thickness of from 10 to 200 nm (preferably 50 to 100 nm) is formed. Similarly, a hydrogenerated silicon oxynitride film formed from SiH₄ and N₂O and having a thickness of from 50 to 200 nm (preferably 100 to 150 nm) is layered thereon. In this embodiment, the base film 3002 has a two-layer structure, but may also be formed as a single layer film of one of the above insulating films, or a laminated film having more than two layers of the above insulating films.

Island-like semiconductor layers 3003 to 3006 are formed from a crystalline semiconductor film obtained by conducting laser crystallization method or a known thermal crystallization method on a semiconductor film having an amorphous structure. Each of these island-like semiconductor layers 3003 to 3006 has a thickness of from 25 to 80 nm (preferably 30 to 60 nm). No limitation is put on the material of the crystalline semiconductor film, but the crystalline semiconductor film is preferably formed from silicon, a silicon germanium (SiGe) alloy, etc.

When the crystalline semiconductor film is to be manufactured by the laser crystallization method, an excimer laser, a YAG laser and an YVO₄ laser of a pulse oscillation type or continuous oscillation type are used. When these lasers are used, it is preferable to use a method in which a laser beam radiated from a laser oscillator is converged into a linear shape by an optical system and then is irradiated to the semiconductor film. A crystallization condition is suitably selected by an operator. When the excimer laser is used, pulse oscillation frequency is set to 300 Hz, and laser energy density is set to from 100 to 400 mJ/cm² (typically 200 to 300 mJ/cm²). When the YAG laser is used, pulse oscillation frequency is preferably set to from 1 to 10 kHz by using its second harmonic, and laser energy density is preferably set to from 300 to 600 mJ/cm² (typically 350 to 500 mJ/cm²). The laser beam converged into a linear shape and having a width of from 100 to 1000 μm, e.g. 400 μm is, is irradiated to the entire substrate surface. At this time, overlapping ratio of the linear laser beam is set to from 80 to 98%.

Next, a gate insulating film 3007 covering the island-like semiconductor layers 3003 to 3006 is formed. The gate insulating film 3007 is formed from an insulating film containing silicon and having a thickness of from 40 to 150 nm by using the plasma CVD method or a sputtering method. In this embodiment, the gate insulating film 3007 is formed from a silicon oxynitride film with a thickness of 120 nm. However, the gate insulating film is not limited to such a silicon oxynitride film, but it may be an insulating film containing other silicon and having a single layer or a laminated layer structure. For example, when a silicon oxide film is used, TEOS (Tetraethyl Orthosilicate) and O₂ are mixed by the plasma CVD method, the reaction pressure is set to 40 Pa, the substrate temperature is set to from 300 to 400° C., and the high frequency (13.56 MHz) power density is set to from 0.5 to 0.8 W/cm² for electric discharge. Thus, the silicon oxide film can be formed by discharge. The silicon oxide film manufactured in this way can then obtain preferable characteristics as the gate insulating film by thermal annealing at from 400 to 500° C.

A first conductive film 3008 and a second conductive film 3009 for forming a gate electrode are formed on the gate insulating film 3007. In this embodiment, the first conductive film 3008 having a thickness of from 50 to 100 nm is formed from Ta, and the second conductive film 3009 having a thickness of from 100 to 300 nm is formed from W.

The Ta film is formed by a sputtering method, and the target of Ta is sputtered by Ar. In this case, when suitable amounts of Xe and Kr are added to Ar, internal stress of the Ta film is released, and the film peeling can be prevented. Resistivity of the Ta film of a phase is about 20 μΩcm, and this Ta film can be used for the gate electrode. However, resistivity of the Ta film of β phase is about 180 μΩcm, and is not suitable for the gate electrode. When tantalum nitride having a crystal structure close to that of the α phase of Ta and having a thickness of about 10 to 50 nm is formed in advance as the base for the Ta film to form the Ta film of the α phase, the Ta film of α phase can be easily obtained.

The W film is formed by the sputtering method with W as a target. Further, the W film can be also formed by a thermal CVD method using tungsten hexafluoride (WF₆). In any case, it is necessary to reduce resistance to use this film as the gate electrode. It is desirable to set resistivity of the W film to be equal to or smaller than 20 μΩcm. When crystal grains of the W film are increased in size, resistivity of the W film can be reduced. However, when there are many impurity elements such as oxygen, etc. within the W film, crystallization is prevented and resistivity is increased. Accordingly, in the case of the sputtering method, a W-target of 99.9999% in purity is used, and the W film is formed by taking a sufficient care of not mixing impurities from a gaseous phase into the W film time when the film is to be formed. Thus, a resistivity of from 9 to 20 μΩcm can be realized.

In this embodiment, the first conductive film 3008 is formed from Ta, and the second conductive film 3009 is formed from. W However, the present invention is not limited to this case. Each of these conductive films may also be formed from an element selected from Ta, W, Ti, Mo, Al and Cu, or an alloy material or a compound material having these elements as principal components. Further, a semiconductor film represented by a polysilicon film doped with an impurity element such as phosphorus may also be used. Examples of combinations other than those shown in this embodiment include: a combination in which the first conductive film 3008 is formed from tantalum nitride (TaN), and the second conductive film 3009 is formed from W; a combination in which the first conductive film 3008 is formed from tantalum nitride (TaN), and the second conductive film 3009 is formed from Al; and a combination in which the first conductive film 3008 is formed from tantalum nitride (TaN), and the second conductive film 3009 is formed from Cu.

Moreover, when you can reduce a LDD region, W single layer structure can be adopted. Even if the structure is the same as that, the length of the LDD region can be reduced by raising the taper corner.

Next, masks 3010-3015 are formed from a resist, and first etching processing for forming an electrode and wiring is performed. In this embodiment, an ICP (Inductively Coupled Plasma) etching method is used, and CF₄ and Cl₂ are mixed with a gas for etching. RF (13.56 MHz) power of 500 W is applied to the electrode of coil type at a pressure of 1 Pa so that plasma is generated. RF (13.56 MHz) of 100 W power is also applied to a substrate side (sample stage), and a substantially negative self-bias voltage is applied. When CF₄ and Cl₂ are mixed, the W film and the Ta film are etched to the same extent.

Under the above etching condition, end portions of a first conductive layer and a second conductive layer are formed into a tapered shape by effects of the bias voltage applied to the substrate side by making the shape of the mask formed from the resist into an appropriate shape. The angle of a taper portion is set to from 15° to 45°. It is preferable to increase an etching time by a ratio of about 10 to 20% so as to perform the etching without leaving the residue on the gate insulating film. Since a selection ratio of a silicon oxynitride film to the W film ranges from 2 to 4 (typically 3), an exposed face of the silicon oxynitride film is etched by about 20 to 50 nm by over-etching processing. Thus, conductive layers 3017 to 3022 of a first shape (first conductive layers 3017a to 3022a and second conductive layers 3017b to 3022b) formed of the first and second conductive layers are formed by the first etching processing. A region that is not covered with the conductive layers 3017 to 3022 of the first shape is etched by about 20 to 50 nm in the gate insulating film 3007, so that a thinned region 3016 is formed. (FIG. 15B)

Second etching processing is next performed without removing the resist masks 3010-3015 as shown in FIG. 15C. A W film is etched selectively by using CF₄, Cl₂ and O₂ as the etching gas. The conductive layers 3024 to 3029 of a second shape (first conductive layers 3024a to 3029a and second conductive layers 3024b to 3029b) are formed by the second etching processing. A region of the gate insulating film 3007, which is not covered with the conductive layers 3024 to 3029 of the second shape, is further etched by about 20 to 50 nm so that a thinned region 3023 is formed.

An etching reaction in the etching of the W film or the Ta film using the mixed gas of CF₄ and Cl₂ can be assumed from the vapor pressure of a radical or ion species generated and a reaction product. When the vapor pressures of a fluoride and a chloride of W and Ta are compared, the vapor pressure of WF₆ as a fluoride of W is extremely high, and vapor pressures of other WCl₅, TaF₅ and TaCl₅ are approximately equal to each other. Accordingly, both the W film and the Ta film are etched using the mixed gas of CF₄ and Cl₂. However, when a suitable amount of O₂ is added to this mixed gas, CF₄ and O₂ react and become CO and F so that a large amount of F-radicals or F-ions is generated. As a result, the etching speed of the W film whose fluoride has a high vapor pressure is increased. In contrast to this, the increase in etching speed is relatively small for the Ta film when F is increased. Since Ta is easily oxidized in comparison with W, the surface of the Ta film is oxidized by adding O₂. Since no oxide of Ta reacts with fluorine or chloride, the etching speed of the Ta film is further reduced. Accordingly, it is possible to make a difference in etching speed between the W film and the Ta film so that the etching speed of the W film can be set to be higher than that of the Ta film.

Then, an impurity element for giving an n-type conductivity is added by performing first doping processing. A doping method may be either an ion doping method or an ion implantation method. The ion doping method is carried out under the condition that a dose is set to from 1×10¹³ to 5×10¹⁴ atoms/cm², and an acceleration voltage is set to from 60 to 100 keV. An element belonging to group 15, typically, phosphorus (P) or arsenic (As) is used as the impurity element for giving the n-type conductivity. However, phosphorus (P) is used here. In this case, the conductive layers 3024 to 3029 serve as masks with respect to the impurity element for giving the n-type conductivity, and first impurity regions 3030 to 3033 are formed in a self-aligning manner. The impurity element for giving the n-type conductivity is added to the first impurity regions 3030 to 3033 in a concentration range from 1×10²⁰ to 1×10²¹ atoms/cm³ (FIG. 15C).

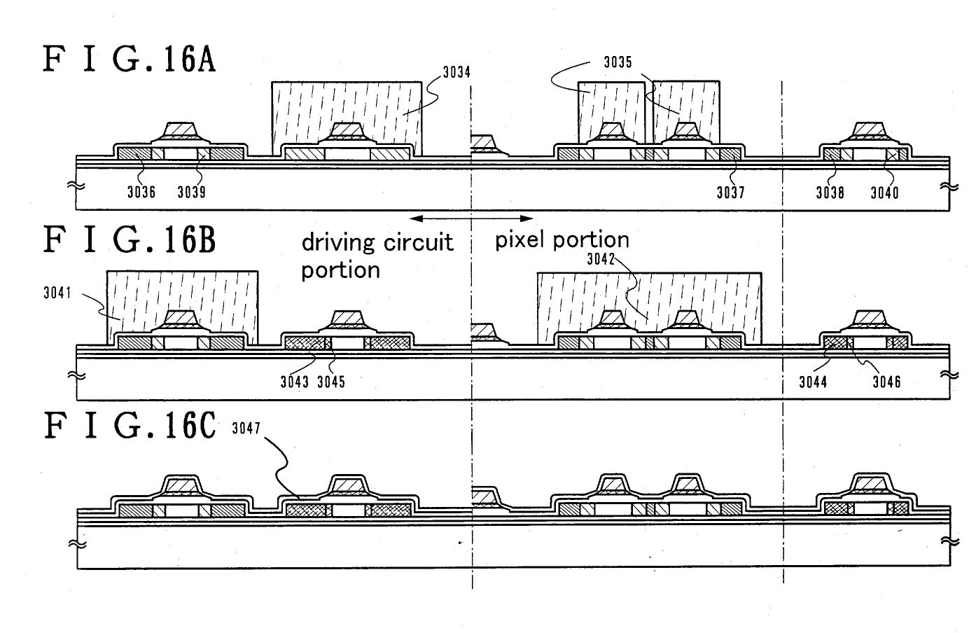

As shown in FIG. 16A, second doping processing is then performed under a condition that p-type TFTs and pixel portion TFTs are covered by the masks 3034, 3035. At this time, the pixel portion TFTs are not covered entirely, outside thereof is opened, thereby performing the second doping. In the second doping processing, an impurity element for giving the n-type conductivity is doped in a smaller dose than that of the first doping processing and at a high acceleration voltage by reducing a dose lower than that in the first doping processing. For example, the acceleration voltage is set to from 70 to 120 keV, and the dose is set to 1×10¹³ atoms/cm². Thus, new impurity regions 3036-3038 are formed inside the first impurity regions 3030-3033 formed in the island-like semiconductor layer in FIG. 15B. In the doping, the conductive layers 3024, 3028 of the second shape are used as masks with respect to the impurity element, and the doping is performed such that the impurity element is also added to regions underside the first conductive layers 3024a, 3028a. Thus, third impurity regions 3039, 3040 are formed. The third impurity regions 3039, 3040 contain phosphorus (P) with a gentle concentration gradient that conforms with the thickness gradient in the tapered portions of the first conductive layers 3024a, 3028a. In the semiconductor layers that overlap the tapered portions of the first conductive layers 3024a, 3028a, the impurity concentration is slightly lower around the center than at the edges of the tapered portions of the first conductive layers 3024a, 3028a. However, the difference is very slight and almost the same impurity concentration is kept throughout the semiconductor layers.

As shown in FIG. 16B, fourth impurity regions 3043 to 3044 having the opposite conductivity type to the first conductivity type are formed in the island-like semiconductor layer 3004 for forming p-channel type TFTs and in the island-like semiconductor layer 3006 for forming the storage capacitor. The second shape conductive layers 3025b and 3028b used as masks against the impurity element are formed in a self-aligning manner. At this point, the island-like semiconductor layer 3003 for forming n-channel type TFTs and pixel portion TFTs 3005 are entirely covered with resist masks 3041, 3042. In the doping, the conductive layers 3025, 3028 of the second shape are used as masks with respect to the impurity element, and the doping is performed such that the impurity element is also added to regions underside the first conductive layers 3024a, 3028a. Thus, fifth impurity regions 3045, 3046 are formed. The impurity regions 3043 to 3044 have already been doped with phosphorus in different concentrations. The impurity regions 3043 to 3044 are doped with diborane (B₂H₆) through ion doping and its impurity concentrations are set to form 2×10²⁰ to 2×10²¹ atoms/cm³ in the respective impurity regions.

Through the steps above, the impurity regions are formed in the respective island-like semiconductor layers. The second shape conductive layers 3024 to 3027 overlapping the island-like semiconductor layers function as gate electrodes. Reference numeral 3029 serves as an island-like source signal. Reference numeral 3028 serves as a storage wiring.

As shown in FIG. 16C, after resist masks 3041, 3042 are removed, a step of activating the impurity elements added to the island-like semiconductor layers is performed to control the conductivity type. This process is performed by a thermal annealing method using a furnace for furnace annealing. Further, a laser annealing method or a rapid thermal annealing method (RTA method) can be applied. In the thermal annealing method, this process is performed at a temperature of from 400 to 700° C., typically from 500 to 600° C. within a nitrogen atmosphere in which oxygen concentration is equal to or smaller than 1 ppm and is preferably equal to or smaller than 0.1 ppm. In this embodiment, heat treatment is performed for four hours at a temperature of 500° C. When a wiring material used in the second shape conductive layers 3024 to 3029 is weak against heat, it is preferable to perform activation after an interlayer insulating film 3047 (having silicon as a principal component) is formed in order to protect wiring, etc.

Further, the heat treatment is performed for 1 to 12 hours at a temperature of from 300 to 450° C. within an atmosphere including 3 to 100% of hydrogen so that the island-like semiconductor layer is hydrogenerated. This step is to terminate a dangling bond of the semiconductor layer by hydrogen thermally excited. Plasma hydrogenation (using hydrogen excited by plasma) may also be performed as another measure for hydrogenation.

Next, a first interlayer insulating film 3047 is formed from a silicon oxynitride film with a thickness of 100 to 200 nm. The second interlayer insulating film 3048 from an organic insulating material such as acrylic and like is formed on the first interlayer insulating film. Further, in place of an organic insulating material, an inorganic material also may be used for the second interlayer insulating film 3048. The inorganic materials include an inorganic SiO2, a SiO2 made by the plasma CVD method, (PCVD-SiO2), a SOG (Spin On Glass; spin silicon oxide film) and the like. After these two interlayer insulating films are formed, an etching process is adopted to form contact holes.

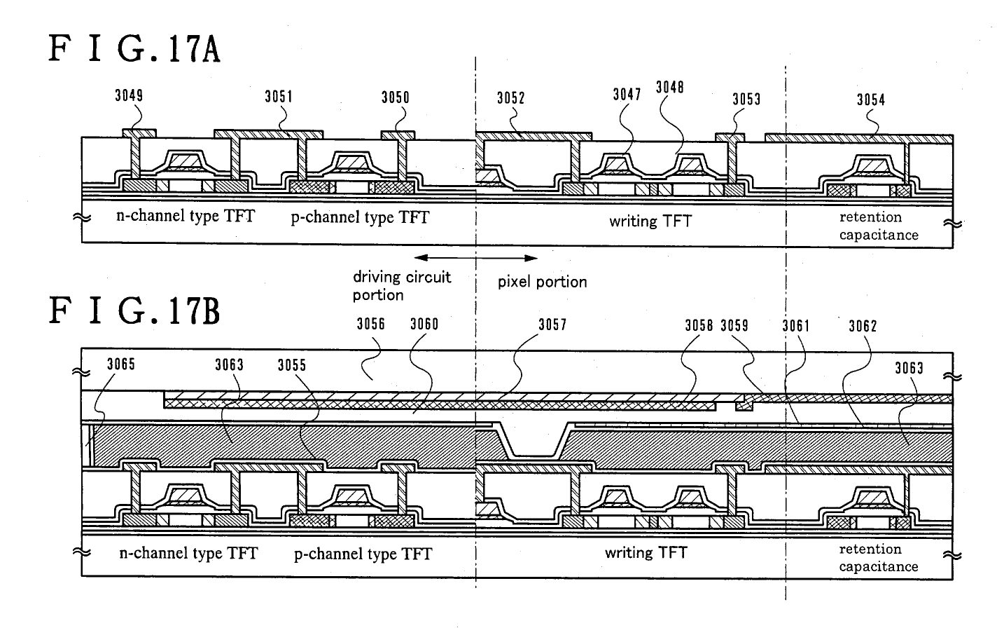

Then, in the driving circuit portion, source wirings 3049, 3050 for contact with the source regions of the island semiconductor layers, and a drain wiring 3051 for contact with the drain regions of the island semiconductor layers are formed. In the pixel portion, a connection electrode 3052 and pixel electrodes 3053, 3054 are formed (FIG. 17A). The connecting electrode 3052 allows electric connection between the source signal line 3029 and writing TFTS. Further, pixel electrodes 3053, 3054 and the storage capacitor are in adjacent pixel.

In this embodiment, though the writing TFT is shown as a double gate structure, a single gate structure, a triple gate structure or even a multi gate structure can also be used.

As described above, the driving circuit portion having the n-channel TFT and the p-channel TFT, the pixel portion having the writing TFT, as well as the storage capacitor can be formed on one substrate. Such a substrate is referred to as an active matrix substrate in this specification.

In this embodiment, end portions of the pixel electrodes are overlapped with source signal lines and writing gate signal lines for the purpose of shielding from spaces between the pixel electrodes without using a black matrix.

Further, according to the process described in this embodiment, the number of photomasks necessary for manufacturing an active matrix substrate can be set to five (a pattern for the island semiconductor layers, a pattern for the first wirings (source signal lines and storage capacitor wirings), a mask pattern for the p-channel regions, a pattern for the contact holes, and a pattern for the second wirings (including the pixel electrodes and the connecting electrodes)). As a result, the process can be made shorter, the manufacturing cost can be lowered, and the yield can be improved.

Next, after the active matrix substrate as illustrated in FIG. 17A is obtained, an orientation film 3055 is formed on the active matrix substrate and a rubbing treatment is carried out.

Meanwhile, an opposing substrate 3056 is prepared. Color filter layers 3057 to 3059 and an overcoat layer 3060 are formed on the opposing substrate 3056. The color filter layers are structured such that the red color filter layer 3057 and the blue color filter layer 3058 overlap over the TFTs so as to serve also as a light-shielding film. Since it is necessary to shield from light at least spaces among the TFTs, the connecting electrodes, and the pixel electrodes, it is preferable that the red color filter and the blue color filter are arranged so as to overlap such that these places are shielded from light.

The red color filter layer 3057, the blue color filter layer 3058, and the green color filter layer 3059 are overlapped so as to align with the connecting electrode 3052. The respective color filters are formed by mixing pigments in an acrylic resin and are formed with a thickness of 1 to 3 μm. These color filters can be formed from a photosensitive material in a predetermined pattern using a mask. The overcoat layer 3060 is formed of a photosetting or thermosetting organic resin material such as a polyimide resin or an acrylic resin.

The arrangement of the spacer may be arbitrarily determined. For example, although, not illustrated here, the spacer may be arranged in the liquid crystal material which is on the connection electrodes. Such spacers may be arranged over the whole surface of the driving circuit portion, or may be arranged so as to cover the source wirings and the drain wirings.

After the overcoat layer 3060 is formed, an opposing electrode 3061 is patterned to be formed, an orientation film 3062 is formed, and a rubbing treatment is carried out.

Then, the active matrix substrate on which the pixel portion, the driving circuit portion and the memory cell are formed is adhered to the opposing substrate using a sealant 3064. Filler is mixed in the sealant 3064. The filler and the spacers help the two substrates to be adhered to each other with a constant gap therebetween. After that, a liquid crystal material 3063 is injected between the substrates, and sealing agent (not shown) carries out full encapsulation. As the liquid crystal material 3063, a known liquid crystal material may be used. In this way, an active matrix liquid crystal display device as illustrated in FIG. 17B is completed.

This embodiment shows an example of TFTs consisted of CMOS, a memory cell can be formed from such TFTs as shown in FIG. 6.

It is to be noted that, though the TFTs in the active matrix type liquid crystal display device formed in the above processes are of a top-gate structure, this embodiment may be applied to TFTs of a bottom-gate structure and of other structures.

(Embodiment 3)

The following description exemplifies the fabrication process in case where the invention is adapted to a reflection type liquid crystal display apparatus, which is different from the liquid crystal display apparatus of the embodiment 2.

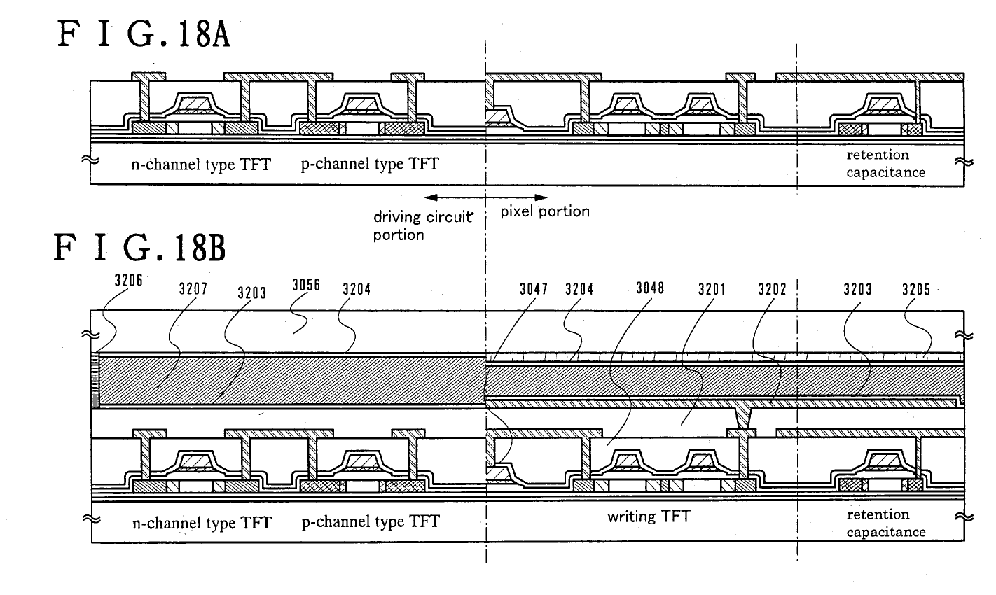

According to the embodiment 2, an active matrix substrate shown in FIG. 18A (similar to the one shown in FIG. 17A) is prepared. Subsequently, a resin film is formed as a third interlayer insulating film 3201 after which a contact hole is bored in the pixel electrode portion and a reflection electrode 3202 is formed there. It is desirable to use a material having an excellent reflectivity, such as a film essentially consisting of Al or Ag or the lamination of those films, as the reflection electrode 3202.

An opposing substrate 3056 is prepared. In this embodiment, an opposing electrode 3205 is formed by patterning on the opposing substrate 3056. The opposing electrode 3205 is formed as a transparent conductive film. An available material for the transparent conductive film is a compound of an indium oxide and tin oxide (which is called ITO) or a compound of an indium oxide and zinc oxide.

At the time of fabricating a color liquid crystal display apparatus, color filter layers, though not particularly illustrated, are formed. It is preferable that adjoining color filter layers of different colors be formed one on the other to serve as a light shielding film for the TFT portion.

Then, alignment films 3203 and 3204 are formed on the active matrix substrate and the opposing substrate and the resultant structure is subjected to a rubbing treatment.

Then, the active matrix substrate on which the pixel portion and the drive circuit portion are formed and the opposing substrate are adhered by a sealant 3206. As a filler is mixed in the sealant 3206, the two substrates are adhered together with a uniform distance provided by the filler and the spacer. Then, a liquid crystal material 3207 is filled between both substrates which are then completely sealed by a sealing agent (not shown). A known liquid crystal material can be used for the liquid crystal material 3207. A reflection type liquid crystal display apparatus as shown in FIG. 18B is completed this way.

The invention can be adapted to a semi-transmission type display apparatus where half the pixels are reflection electrodes and the remaining half thereof are transparent electrodes.

(Embodiment 4)

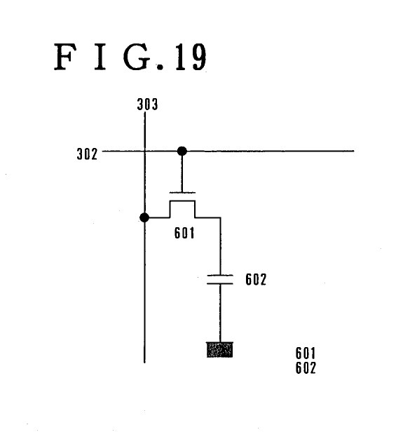

A frame memory having a different construction from that of the frame memory shown in FIG. 6 in the embodiment 1 of the present invention will be described based on FIG. 19. For convenience of the explanation, the same reference numerals are given to members having the same functions as those shown in the drawings relating to the embodiment1, and the explanations thereof are omitted.

The frame memory in a liquid crystal display device according to this embodiment has a DRAM construction, as shown in FIG. 19. Like the embodiment 1, the memory capacity of the frame memory meets the following requirements:

Memory capacity≧number of pixels×number of tones×number of colors

where the number of colors is 3 in RGB color and 1 in monochrome color and black and white. The number of tones is expressed by the number of bits and 8 in 256 tones, 6 in 64 tones and 3 in 8 tones.

While a source electrode in a transistor 601 for the memory is connected to a data line 303, the gate electrode is connected to a word line 302.

The drain electrode of the transistor 601 for the memory is connected to a data retention capacity 602. By applying a predetermined voltage to the word line 302, the transistor 601 for the memory is turned ON. Thus, data to for display, which is supplied to the data line 303, is stored in the data retention capacity 602. Also, by applying a predetermined voltage to the word line 302 for reading data, the transistor 601 for the memory is turned on, and the data for display, which is stored in the data retention capacity 602, is read out through the data line 303.

Here, a refresh circuit required for a general DRAM can be removed if the frame memory has enough capacity. This is because, in this embodiment, the data for display is read out or rewritten for each of 1/z (where z is the number calculated by dividing entire frame memory capacity by a unit frame) of one frame period by using a part of the frame memory.

This embodiment can be implemented by combining the embodiments 1 to 3 freely.

(Embodiment 5)

In the present invention, a display device using liquid crystal can be replaced by a display device using light emitting elements. In this specification, light emitting elements denote that elements emits light at a brightness corresponding to a flowing current, and elements emits light at a brightness corresponding to a voltage applied.

As a light emitting element that is arranged in each pixel of the display device of the present invention, OLED elements, elements that use an electron source element, an element that emits light in each pixel when the electrical current flows can be freely used.

In this embodiment, the light emitting element that is arranged in each pixel of the display device of the present invention is formed by using MIM type electron source element. And an example of forming the display device is described.

MIM type electron source element draws an attention as an element that can be reduced in size, formed having uniform characteristics, and driven with low-voltage.

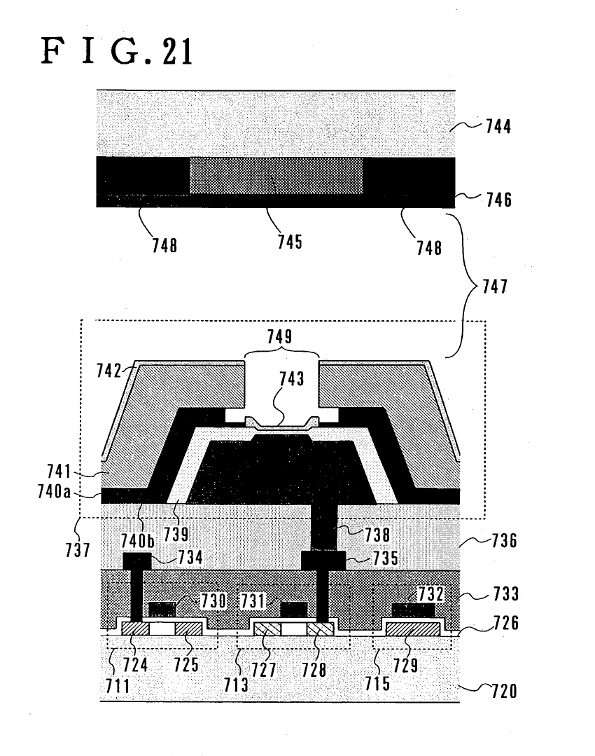

FIG. 21 shows a cross-sectional view illustrating the pixel configuration of the display device of the present invention.

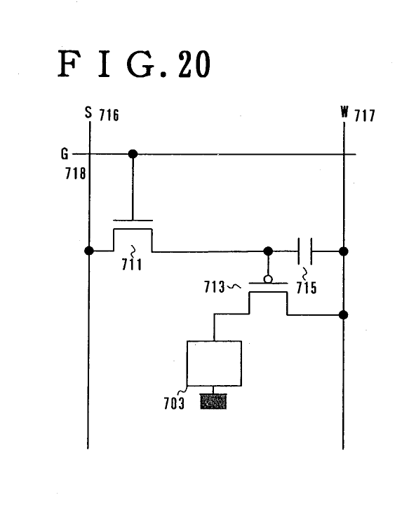

As shown in FIG. 20, the pixel configuration illustrates a switching transistor 711, a driver transistor 713, an electron source 703 and a storage capacitor 715. When a signal is inputted to a gate line 718, the switching transistor 711 turns to ON state, then, the driver transistor 713 receives the signal of a source line 716 and turns to ON state. Accordingly, the electric potential of a power supply line 717 is applied to the electron source 703, thereby the electron source 703 emitting light.

Even the signal of the gate line 718 breaks, the driver transistor 713 can be moved by the storage capacitor 715 while the charge is remained therein. However, this capacitor may be replaced by a parasitic capacitor generated in the circuits, therefore, it is not indispensable.

FIG. 21 is a cross-sectional view of the switching transistor 711 which serves as a switching element, the driver transistor 713, the storage capacitor 715 and light emitting elements. Note that an example that the switching transistor 711 and the driver transistor 713 are formed by using TFTs is described here.

In FIG. 21, the switching transistor 711, the driver transistor 713, the storage capacitor 715 and the electron source element 737, are formed in sequence on a substrate 720 having an insulating surface. The electron source element 737 is comprised of a bottom electrode 738, a top electrode 743, and an insulating film 739 sandwiched between the bottom electrode 738 and the top electrode 743 on an insulating film 736 made of insulator. The reference numeral 726 is a gate insulating film, 733 is a interlayer insulating film, 741 is a protective insulating layer, 740a is a contact electrode, 740b is a top electrode bus line, and 742 is a protective electrode.

A gate electrode 730 of the switching transistor 711 is connected to the scanning line (not illustrated). The impurity region 724 of the switching transistor 711 is connected to the signal line 734, and the impurity region 725 is connected to the gate electrode 731 of the driver transistor 713, or either electrode 732 of the storage capacitor 715. Either electrode 729 of the storage capacitor 715 is connected to the power source line W (not illustrated). The impurity region 727 of the driver transistor 713 is connected to the power source line W (not illustrated). The impurity region 728 of the driver transistor 713 is connected to an wiring(electrode) 735. The wiring(electrode) 735 is connected to the bottom electrode 738 of the electron source element 737. A constant electric potential is applied to the top electrode 743 of the electron source element 737 via the contact electrode 740a and the top electrode bus line 740b in all pixels.

Here, the impurity region corresponds to the source or drain region of TFT In the case that the impurity region 724 is a source region, the impurity region 725 corresponds to the drain region. In the case that the impurity region 724 is a drain region, the impurity region 725 corresponds to the source region. Similarly, in the case that the impurity region 727 is a source region, the impurity region 728 corresponds to the drain region, in the case that the impurity region 727 is a drain region, the impurity region 728 corresponds to the source region.

FIG. 21 described that the pixel electrode is a bottom electrode 738, however the pixel electrode can be a top electrode. At this time, a constant electric potential is applied to the bottom electrode in all pixels.

A substrate 744 is provided so as to face with the substrate 720 on which said electron source element 737 is provided. In addition, the substrate 744 is transparent to light. On the substrate 744, a fluorescent material 745 is provided so as to face up to an electron discharge region 749 of said electron source element 737. In the periphery of the fluorescent material 745, a black matrix 748 is provided. Further, a metal back layer 746 is formed on the surface of the fluorescent material 745. The empty space 747 between the substrate 720 and the substrate 744 is maintained at a vacuum state.

As the manufacturing method of the switching transistor 711, the driver transistor 713, and the storage capacitor 715, a known method can be freely used. When these TFTs are formed, the insulating film 736 made of insulator and the electron source element are formed thereon in sequence. At this time, it is necessary that the irregularities of the switching transistor 711, the driver transistor 713, the storage capacitor 715, and the wiring 735 are smoothed sufficiently and that materials and thickness are selected in order to obtain flat surface.

The electron source element 737 is formed on the smoothed insulating surface. Forming a contact hole connected to the wiring 735 of the driver transistor 713 on the smoothed interlayer film 736 before forming the electron source element, the bottom electrode and the driver transistor 713 can be connected to the wiring 735 simultaneously with the formation of the bottom electrode. As the manufacturing method of the electron source element 737, known method can be used.

Here, the bottom electrode 738 of the electron source element 737 can be used as a light-shielding film of the pixel TFT (the switching transistor 711, the driver transistor 713).

It is not always necessary that the electron source element is arranged to overlap with the TFT (the switching transistor 711, the driver transistor 713) comprising a pixel.

By application of the voltage between the top electrode 743 and the bottom electrode 738, the hot carrier is injected to the insulating film 739. Among the injected hot carrier, the one that has bigger energy than that of the work function of materials for the top electrode 743 is discharged into vacuum passing through the top electrode 743.

The electron discharged in the vacuum is thus accelerated in the empty space 747 by a voltage between the metal back layer 746 and the top electrode 743. The accelerated electron is entered into the fluorescent material 745 provided on the substrate 744 via the metal back layer 746. Accordingly, the fluorescent material 745 in which the electron entered emits light.

In the display device having the pixel shown in this embodiment, the electron source element is arranged to overlap with TFT of each pixel, so that the microscopic pixel can be formed.

In this embodiment, along with the embodiment in which liquid crystal is used in the display portion, pixels, driver circuits and memory cells can be integrally formed in one substrate, as a result, a display device which has the higher reading speed from memory, low signal noise effects, lower electric power consumption can be offered.

In this embodiment, the display device (FED) that displays by using a MIM type electron source element shown in FIG. 21 is described as an example. The present invention can be applied to the MIM electron source element having other configuration, the electron source element having a configuration except the MIM type, and the electron source element having all-known configurations. This embodiment can be implemented by freely combining with embodimentm 1 or embodiment 4.

(Embodiment 6)

The configuration of a display device using light emitting elements in place of liquid crystal different from the one shown in embodiment 5, is described as below.

For the light emitting element, an OLED (organic light emitting diode) is described as an example. In this specification, an OLED denotes a configuration having an anode, a cathode, and an organic component layer sandwiched between the anode and the cathode. The anode and the cathode correspond to a first and a second electrode, respectively. Then, an OLED emits light by applying a voltage between electrodes.

An organic compound layer usually has a laminated structure. A typical laminated structure thereof is one proposed by Tang et al. of Eastman Kodak Company and consisting of a hole transporting layer, a light emitting layer, and an electron transporting layer. Other examples of the laminated structure include one in which a hole injection layer, a hole transporting layer, a light emitting layer, and an electron transporting layer are layered in order on an anode, and one in which a hole injection layer, a hole transporting layer, a light emitting layer, an electron transporting layer, and an electron injection layer are layered in order on an anode. A light emitting layer may be doped with a fluorescent pigment or the like.

In this specification, all layers provided between the anode and the cathode generally are called an organic compound layer. The above-mentioned hole injection layer, hole transporting layer, light emitting layer, electron transporting layer, electron injection layer, and other layers are all included in the organic compound layer.

A given voltage is applied to an organic compound layer structured as above from a pair of electrodes (an anode and a cathode) to induce recombination of carriers in its light emitting layer. As a result, the light emitting layer emits light. Note that in this specification, emitting an OLED is referred to as driving an OLED.

An OLED in this specification refers to an OLED that uses a singlet exciton to emit light (fluorescent light), an element that uses a triplet exciton to emit light (phosphorescent light), or an OLED that uses the both.

Further, any one of a low molecular material, a high molecular material, and an intermediate molecular material can be a material for an organic compound layer of OLED.

Note that an intermediate molecular material in this specification denotes a material without sublimation property and the length of a linked molecular is 10 μm or less.

A method of simultaneously manufacturing a pixel portion and driver circuits provided in the periphery of the pixel portion of a display device of the present invention, is explained as below. That transistors consisting of the pixel portion and driver circuits provided in the periphery of the pixel portion are in case of TFTs is described as an example. Further, that a light emitting elements in each pixel is in case of an OLED is described as an example.

Further, that the configuration of each pixel is the one shown in FIG. 20 is described as an example. Here, in place of the electron source element 703, an OLED is used. However, for the simplification, a CMOS circuit that is a base unit of the driver circuit portion will be illustrated. Further, as the transistors consisting of the pixel portion, a switching transistor and a driver transistor is shown.

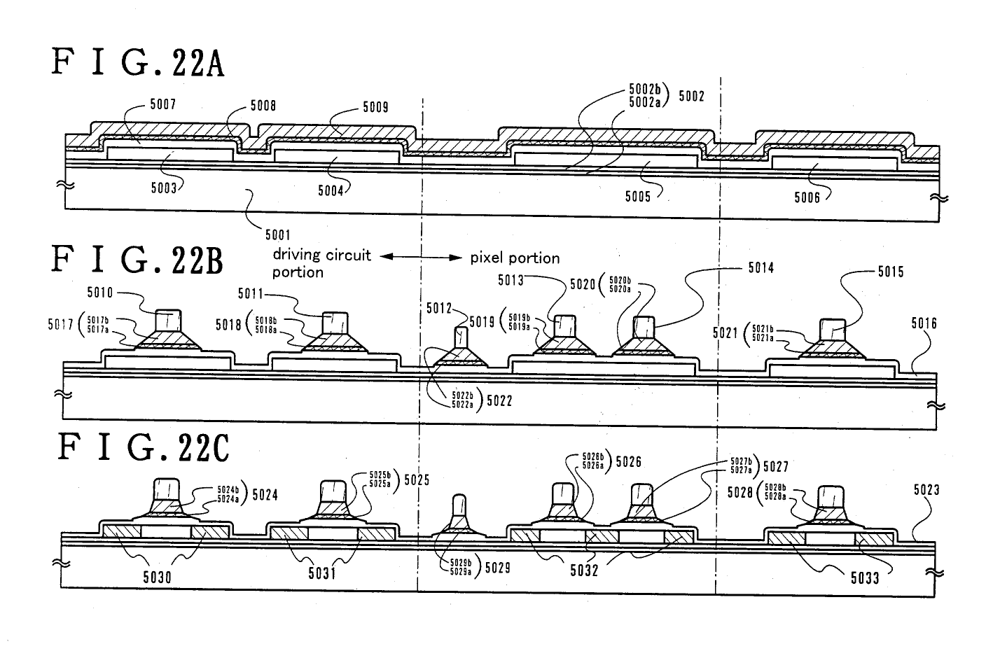

First, as shown in FIG. 22A, a base film 5002 made of an insulating film such as a silicon oxide film, a silicon nitride film, or a silicon oxynitride film is formed on a substrate 5001 made from glass, such as barium borosilicate glass or aluminum borosilicate glass, typified by Corning Corp. #7059 glass or #1737 glass. For example, a silicon oxynitride film 5002a manufactured from SiH₄, NH₃, and N₂O by plasma CVD is formed with a thickness of 10 to 200 nm (preferably from 50 to 100 nm), and a hydrogenated silicon oxynitride film 5002b with a thickness of 50 to 200 nm (preferably between 100 and 150 nm), manufactured from SiH₄ and N₂O, is similarly formed and laminated. The base film 5002 with the two layer structure is shown in Embodiment 6, but the base film 5002 may also be formed as a single film or as a lamination film in which two or more layers are laminated.

Island shape semiconductor layers 5003 to 5006 are formed of crystalline semiconductor film manufactured by using a laser crystallization method or a known thermal crystallization method with a semiconductor film having an amorphous structure. The thickness of the island shape semiconductor layers 5003 to 5006 is set from 25 to 80 nm (preferably between 30 and 60 nm). There are no limitations on the crystalline semiconductor film material, but it is preferable to form the film from a semiconductor material such as silicon or a silicon germanium (SiGe) alloy.

A laser such as a pulse oscillation type or continuous emission (continuous oscillation) type excimer laser, a YAG laser, or a YVO₄ laser can be used as a laser light source in manufacturing the crystalline semiconductor film with the laser crystallization method. A method of condensing laser light emitted from a laser oscillator into a linear shape by an optical system and then irradiating the light to the semiconductor film may be employed when these types of lasers are used. The crystallization conditions may be suitably selected by the operator. However, the pulse oscillation frequency is set to 300 Hz, and the laser energy density is set from 100 to 400 mJ/cm² (typically between 200 and 300 mJ/cm²) when using the excimer laser. Further, the second harmonic is utilized when using the YAG laser, the pulse oscillation frequency is set from 1 to 10 Hz, and the laser energy density may be set from 300 to 600 mJ/cm² (typically between 350 and 500 mJ/cm²). The laser light that has been condensed into a linear shape with a width of 100 to 1000 μm, for example 400 μm, is then irradiated onto the entire surface of the substrate. This is performed with an overlap ratio of 80 to 98% for the linear laser light.

A gate insulating film 5007 is formed covering the island shape semiconductor layers 5003 to 5006. The gate insulating film 5007 is formed of an insulating film containing silicon having a thickness of 40 to 150 nm by plasma CVD or sputtering. A 120 nm thick silicon oxynitride film is formed in this embodiment. The gate insulating film is not limited to this type of silicon oxynitride film, of course, and other insulating films containing silicon may also be used, in a single layer or in a lamination structure. For example, when using a silicon oxide film, it can be formed by plasma CVD with a mixture of TEOS (tetraethyl orthosilicate) and O₂, at a reaction pressure of 40 Pa, with the substrate temperature set from 300 to 400° C., and by discharging at a high frequency (13.56 MHZ) electric power density of 0.5 to 0.8 W/cm². Good characteristics as a gate insulating film can be obtained by subsequently performing thermal annealing, at a temperature between 400 and 500° C., of the silicon oxide film thus manufactured.

A first conductive film 5008 and a second conductive film 5009 are then formed on the gate insulating film 5007 in order to form gate electrodes. The first conductive film 5008 is formed from Ta with a thickness of 50 to 100 nm, and the second conductive film 5009 is formed by W with a thickness of 100 to 300 nm, in this embodiment.

The Ta film is formed by sputtering, and sputtering with a Ta target is performed by using Ar. If appropriate amounts of Xe and Kr are added to the Ar during sputtering, the internal stress of the Ta film will be relaxed, and film peeling can be prevented. The resistivity of α phase Ta film is on the order of 20 μΩcm, and it can be used in the gate electrode, but the resistivity of β [symbol] phase Ta film is on the order of 180 μΩcm and it is unsuitable for the gate electrode. The α phase Ta film can easily be obtained if a tantalum nitride film, which possesses a crystal structure near that of α phase Ta, is formed with a thickness of 10 to 50 nm as a base for Ta in order to form the [symbol] phase Ta film.

A W film is formed by sputtering with a W target. The W film can also be formed by thermal CVD using tungsten hexafluoride (WF₆). Whichever is used, it is necessary to make the film become low resistance in order to use it as the gate electrode, and it is preferable that the resistivity of the W film be made equal to or less than 20 μΩcm. The resistivity can be lowered by enlarging the crystals of the W film, but for cases in which there are many impurity elements such as oxygen within the W film, crystallization is inhibited, and the film becomes high resistance. A W target having a purity of 99.9999% is thus used in sputtering. In addition, the W film is formed while sufficient care is taken in order that no impurities from within the gas phase are introduced at the time of film formation. Thus, a resistivity of 9 to 20 μΩcm can be achieved.

Note that, although the first conductive film 5008 is Ta and the second conductive film 5009 is W in this embodiment, the conductive films are not limited to these. Both the first conductive film 5008 and the second conductive film 5009 may also be formed from an element selected from the group consisting of Ta, W, Ti, Mo, Al, and Cu, from an alloy material having one of these elements as its main constituent, or from a chemical compound of these elements. Further, a semiconductor film, typically a polysilicon film, into which an impurity element such as phosphorous is doped may also be used. Examples of preferable combinations other than that used in this embodiment include: a combination of the first conductive film 5008 formed from tantalum nitride (TaN) and the second conductive film 5009 formed from W; a combination of the first conductive film formed from tantalum nitride (TaN) and the second conductive film 5009 formed from Al; and a combination of the first conductive film 5008 formed from tantalum nitride (TaN) and the second conductive film 5009 formed from Cu.

Masks 5010 to 5015 are formed next from resist, and a first etching process is performed in order to form electrodes and wirings. An ICP (inductively coupled plasma) etching method is used in this embodiment. A gas mixture of CF₄ and Cl₂ is used as an etching gas, and plasma is generated by applying a 500 W RF electric power (13.56 MHZ) to a coil shape electrode at 1 Pa. A 100 W RF electric power (13.56 MHZ) is also applied to the substrate side (test piece stage), effectively applying a negative self-bias. The W film and the Ta film are both etched on the same order when CF₄ and Cl₂ are combined.

Edge portions of the first conducting layer and the second conducting layer are made into a tapered shape in accordance with the effect of the bias voltage applied to the substrate side with the above etching conditions by using a suitable resist mask shape. The angle of the tapered portions is from 15 to 4° [symbol] . The etching time may be increased by approximately 10 to 20% in order to perform etching without any residue remaining on the gate insulating film. The selectivity of a silicon oxynitride film with respect to a W film is from 2 to 4 (typically 3), and therefore approximately 20 to 50 nm of the exposed surface of the silicon oxynitride film is etched by this over-etching process. First shape conductive layers 5017 to 5022 (first conductive layers 5017a to 5022a and second conductive layers 5017b to 5022b) composed of the first conducting layer and the second conducting layer are thus formed by the first etching process. Portions of the gate insulating film 5007 not covered by the first shape conductive layers 5017 to 5022 are etched on the order of 20 to 50 nm, forming thinner regions. (See FIG. 22B.)

A second etching process is performed without removing resist mask next as shown in FIG. 22C. The W film is etched selectively using a mixture of CF₄, Cl₂, and O₂ is used as the etching gas. At that time, by the second etching process, second shape conductive layers 5024 to 5029 (first conductive layers 5024a to 5029a and second conductive layers 5024b to 5029b) are formed. The gate insulating film 5007 is additionally etched on the order of 20 to 50 nm, forming a thinner region 5023, in regions not covered by the second shape conductive layers 5024 to 5029.

The etching reaction of the W film or the Ta film in accordance with the mixed gas of CF₄ and Cl₂ can be estimated from the generated radicals, or from the ion types and vapor pressures of the reaction products. Comparing the vapor pressures of W and Ta fluorides and chlorides, the W fluoride compound WF₆ is extremely high, and the vapor pressures of WCl₅, TaF₅, and TaCl₅ are of similar order. Therefore, the W film and the Ta film are both etched by the CF₄ and Cl₂ gas mixture. However, if a suitable quantity of O₂ is added to this gas mixture, CF₄ and O₂ react, forming CO and F, and a large amount of F radicals or F ions are generated. As a result, the etching speed of the W film having a high fluoride vapor pressure becomes high. On the other hand, even if F increases, the etching speed of Ta does not relatively increase. Further, Ta is easily oxidized compared to W, and therefore the surface of Ta is oxidized by the addition of O₂. The etching speed of the Ta film is further reduced because Ta oxides do not react with fluorine and chlorine. It therefore becomes possible to have a difference in etching speeds of the W film and the Ta film, and it becomes possible to make the etching speed of the W film larger than that of the Ta film.

A first doping process is then performed, and an impurity element that imparts n-type conductivity is added. Ion doping or ion injection may be performed as the doping method. Ion doping is performed at conditions in which the dosage is set to 1×10¹³ to 5×10¹⁴ atoms/cm², and an acceleration voltage is set between 60 and 100 keV. An element residing in group 15 of the periodic table, typically phosphorous (P) or arsenic (As), is used as the n-type conductivity imparting impurity element. Phosphorous (P) is used here. The conductive layers 5024 to 5029 become masks with respect to the n-type conductivity imparting impurity element, and first impurity regions 5030 to 5033 are formed in a self-aligning manner. The impurity element that imparts n-type conductivity is added to the first impurity regions 5030 to 5033 at a concentration within a range of 1×10²⁰ and 1×10²¹ atoms/cm³. (See FIG. 22C.)

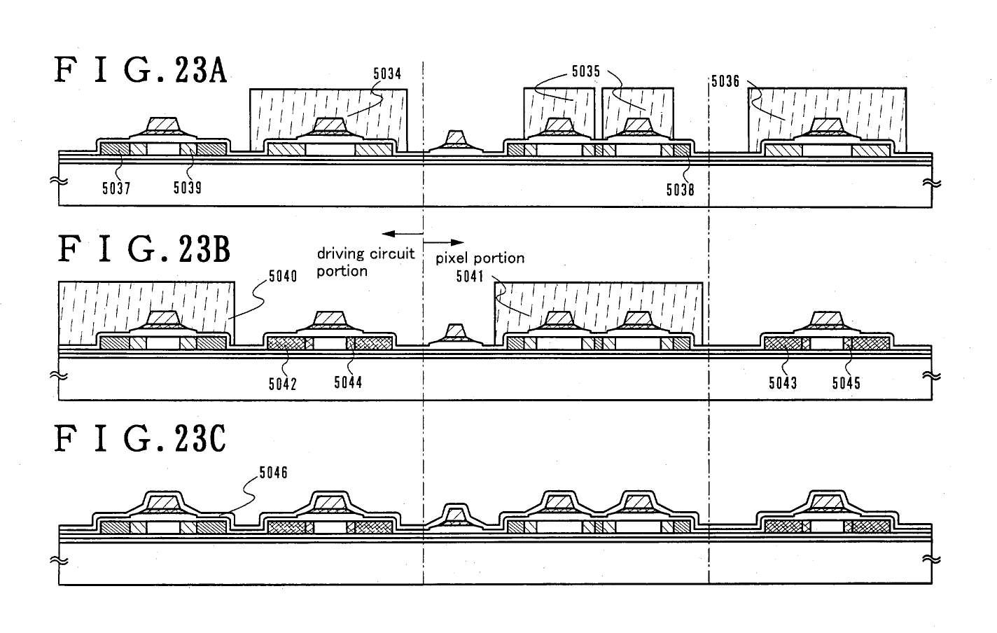

A second doping process is then performed as shown in FIG. 23A. At this time, along with the liquid crystal process, p-type TFTs, switching transistors and driver transistors are covered by resist masks 5034 to 5036. However, the switching transistors are not entirely covered by the resist masks, the outside portion thereof is opened and the doping is performed thereon. For the second doping process, an impurity element, which imparts n-type conductivity, is doped under conditions of a lower dosage than that in the first doping process, and at a higher acceleration voltage than that in the first doping process. For example, doping may be performed at an acceleration voltage of 70 to 120 keV and with a dosage of 1×10¹³ atoms/cm², forming new impurity regions 5037 and 5038 inside the first impurity regions 5030 to 5033 formed in the island shape semiconductor layers of FIG. 22C. Doping is performed with the second shape conductive layer 5024 as a mask with respect to the impurity element, and doping is done such that the impurity element is also added to regions below the first conductive layer 5024a where is not covered by the mask. Third impurity region 5039 is formed. A concentration of phosphorus (P) added to the third impurity region 5039 is provided with a gradual concentration gradient in accordance with a film thickness of the taper portion of the first conductive layer 5024a. Further, in the semiconductor layer overlapping the taper portion of the first conductive layer 5024a, from an end portion of the taper portion of the first conductive layer 5024a toward an inner side, the impurity concentration is more or less reduced, however, the concentration stays to be substantially the same degree.

Then, as shown in FIG. 23B, the fourth impurity regions 5042, 5043 are formed, which have a conductivity type opposite to the first conductivity type, in the island-like semiconductor layers 5004, 5006 forming p-channel TFTs. The second conductive layers 5025b and 5028b are used as masks to an impurity element, and the impurity regions are formed in a self-aligning manner. At this time, the whole surfaces of the island-like semiconductor layers 5003 and the switching transistor 5005 which form n-channel TFTs are covered with resist masks 5040, 5041. Doping is performed with the second shape conductive layers 5025, 5028 as masks with respect to the impurity element, and doping is done such that the impurity element is also added to regions below the first conductive layers 5025a, 5028a where are not covered by the masks. Fifth impurity regions 5044, 5045 are thus formed. Although phosphorus is added to the impurity regions 5042 to 5043 at different concentrations, respectively, the regions are formed by an ion doping method using diborane (B₂H₆) and the impurity concentration is made 2×10²⁰ to 2×10²¹ atoms/cm³ in any of the regions.

By the steps up to this, the impurity regions are formed in the respective island-like semiconductor layers. The second shape conductive layers 5024 to 5028 overlapping with the island-like semiconductor layers function as gate electrodes. The conductive layer 5029 functions as an island-like source signal line.

After the resist masks 5040, 5041 are removed, a step of activating the impurity elements added in the respective island-like semiconductor layers for the purpose of controlling the conductivity type is conducted. This step is carried out by a thermal annealing method using a furnace annealing oven. In addition, a laser annealing method or a rapid thermal annealing method (RTA method) can be applied. The thermal annealing method is performed in a nitrogen atmosphere having an oxygen concentration of 1 ppm or less, preferably 0.1 ppm or less and at a temperature from 400 to 700° C., typically 500 to 600° C. In this embodiment, a heat treatment is conducted at 500° C. for four hours. However, in the case where a wiring material used for the second conductive layers 5024 to 5029 is weak to heat, it is preferable that the activation is performed after an interlayer insulating film (containing silicon as its main ingredient) is formed to protect the wiring line or the like.

Further, a heat treatment at a temperature from 300 to 450° C. for 1 to 12 hours is conducted in an atmosphere containing hydrogen of 3 to 100%, and a step of hydrogenating the island-like semiconductor layers is conducted. This step is a step of terminating dangling bonds in the semiconductor layer by thermally excited hydrogen. As another means for hydrogenation, plasma hydrogenation (using hydrogen excited by plasma) may be carried out.

Next, as shown in FIG. 23C, a first interlayer insulating film 5046 made of a silicon nitride oxide film having a thickness of 100 to 200 nm is formed. A second interlayer insulating film 5047 made of an organic insulating material formed thereon. Contact holes are then formed with respect to the first interlayer insulating film 5046, the second interlayer insulating film 5047, and the gate insulating film 5007, respective wirings (including connection wirings and signal lines) 5048 to 5053, and 5055 are formed by patterning, and then, a pixel electrode 5054 that contacts with the connection wiring 5053 is formed by patterning.

Next, the film made from organic resin is used for the second interlayer insulating film 5047. As the organic resin, polyimide, polyamide, acryl, BCB (benzocyclobutene) or the like can be used. Especially, since the second interlayer insulating film 5047 has rather the meaning of flattening, acryl excellent in flatness is desirable.

An inorganic material also may be used for the second interlayer insulating film 5047. Particularly, using the inorganic material, by virtue of moisture-absorption thereof, the deterioration of OLED material can be prevented. The inorganic materials include an inorganic SiO₂, a SiO₂ made by the plasma CVD method (PCVD-SiO2), a SOG (Spin On Glass; spin silicon oxide film) and the like. In this embodiment, the SOG film is formed to such a thickness that stepped portions formed by the TFTs can be adequately flattened.

In the formation of the contact holes, dry etching or wet etching is used, and contact holes reaching the n-type impurity regions or the p-type impurity regions, a contact hole reaching the wiring, a contact hole reaching the power source supply line (not illustrated), and contact holes reaching the gate electrodes (not illustrated) are formed, respectively.

Further, a lamination film of a three layer structure, in which a 100 nm thick Ti film, a 300 nm thick aluminum film containing Ti, and a 150 nm thick Ti film are formed in succession by sputtering, is patterned into a desirable shape, and the resultant lamination film is used as the wirings (connection wirings) 5048 to 5053, and 5055. Of course, other conductive films may be used.

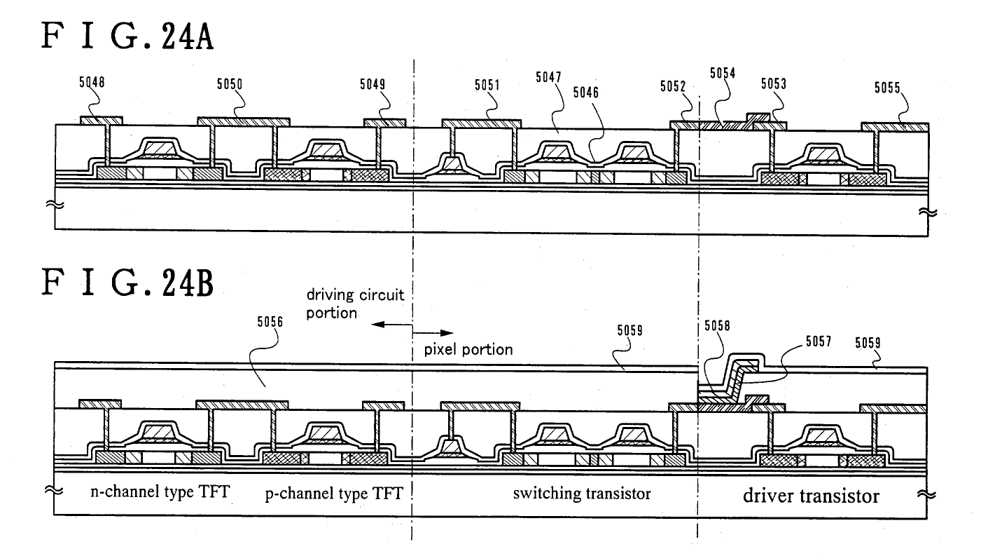

In this embodiment, further, an ITO film is formed maintaining a thickness of 110 nm as a pixel electrode 5054 and is patterned. The pixel electrode 5054 is overlapped on the connection wiring 5053 in contact therewith. It is also allowable to use a transparent electrically conducting film by mixing 2 to 20% of zinc oxide (ZnO) into indium oxide. The pixel electrode 5054 serves as an anode of the OLED. (See FIG. 24A.)

Referring next to FIG. 24B, the insulating film containing silicon (an inorganic SiO₂ film in this embodiment) is formed maintaining a thickness of 500 nm, an opening is formed at a position corresponding to the pixel electrode 5054, and a third interlayer insulating film 5056 is formed to serve as a bank. The opening is formed by the wet etching method thereby to easily form the tapered side walls. Attention must be given to that unless the side walls of the opening portion are formed sufficiently mildly, the organic compound layer is deteriorated to a conspicuous degree due to a step. Examples of the combinations of the second interlayer insulating film 5047 and the third interlayer insulating film 5056 are as below: 1, PCVD-SiO₂ and PCVD-SiO₂; 2, SOG and SOG; 3, PCVD-SiO₂ on SOG and PCVD-SiO₂; 4, acryl and acryl; 5, SiO₂ on acryl and PCVD-SiO₂; 6, PCVD-SiO₂ and acryl; and the like.

Next, the organic compound layer 5057 and the cathode (MgAg electrode) 5058 are continuously formed by the vacuum evaporation method without being exposed to the open air. Here, the organic compound layer 5057 should have a thickness of 80 to 200 nm (typically, 100 to 120 nm) and the cathode 5058 should have a thickness of 180 to 300 nm (typically, 200 to 250 nm).

At this step, there are successively formed the organic compound layer and the cathode for the pixel corresponding to red color, for the pixel corresponding to green color and for the pixel corresponding to blue color. Here, however, the organic compound layer has a poor resistance against the solution and must be separately formed for each of the colors without relying upon the photolithography technology. It is therefore desired to employ a method such as evaporation method of selectively forming the organic compound layer and the cathode on the required portions only while concealing the areas except the desired pixels by using a metal mask.

First, a mask is set to conceal all areas except the pixels corresponding to red color, and the organic compound layer that emits red light is selectively formed by using the mask. Next, a mask is set to conceal all areas except the pixels corresponding to green color, and the organic compound layer that emits green light is selectively formed by using the mask. Then, a mask is set to conceal all areas except the pixels corresponding to blue color and the organic compound layer that emits blue light is selectively formed by using the mask. Though different masks were used above, it is also allowable to use the same mask.

Though in the foregoing was used the system for forming OLEDs of three kinds corresponding to RGB, there may be used a system combining a white OLED and a color filter, a system combining a blue or blue-green OLED and a fluorescent material (fluorescent color conversion layer: CCM) or a system using a transparent electrode as the cathode (opposing electrode) and overlapping thereon OLEDs corresponding to RGB.

Known materials can be used for forming the organic compound layer 5057. As the known material, there can be preferably used an organic material by considering the driving voltage. For example, four layers comprising a hole-injection layer, a hole-transporting layer, a light-emitting layer and an electron-injection layer may be used as the organic compound layer.

Next, a cathode 5058 is formed by using a metal mask on the pixels (pixels of the same line) having the switching transistors of which the gate electrodes are connected to the same gate signal line. Though MgAg, which is a cathode material, was used for the cathode 5058 in this embodiment, it should be noted that the invention is not limited thereto only, but any other known material may be used as the cathode 5058.

Finally, a passivation film 5059 made of a silicon nitride film is formed maintaining a thickness of 300 nm. Upon forming the passivation film 5059, the organic compound layer 5057 is protected from the moisture so as to exhibit further improved reliability of OLEDs.

Thus, the OLED display device of a structure shown in FIG. 24B is completed. In the step of forming the OLED display device according to this embodiment, the source signal lines are formed by using Ta and W which are the materials forming the gate electrodes, and the gate signal lines are formed by using Al which is a wiring material forming the drain electrodes due to the circuit constitution and the steps. It is, however, allowable to use different materials, too.

Upon arranging TFTs of an optimum structure not only in the pixel portion but also in the driving circuit portion, the OLED display device of this embodiment exhibits a very high reliability and improved operation characteristics. In the step of crystallization, further, it is also allowable to add a metal catalyst such as Ni to enhance the crystallinity. Accordingly, the driver frequency of the signal line driver circuits can be set at 10 MHz or more.

First, in order to prevent the drop in the operation speed as much as possible, the TFT of a structure, which suppresses the injection of hot carriers, is used as the n-channel TFT for the CMOS circuit that forms the driving circuit portion.

In the case of this embodiment, the active layer of the n-channel TFTs each includes the source region, drain region, overlapped LDD region (referred to L_{OV} region) overlapped on the gate electrode with the gate insulating film sandwiched therebetween, an offset LDD region (referred to L_{OFF} region) which is not overlapped on the gate electrode with the gate insulating film sandwiched therebetween, and channel-forming region.

The p-channel TFT of the CMOS circuit needs not be particularly provided with the LDD region since it is not almost deteriorated by the injection of hot carriers. It is, of course, allowable to provide the LDD region like the n-channel TFT to cope with the hot carriers.

Further, when the driving circuit employs the CMOS circuit in which the current flows in both directions through the channel forming region, i.e., employs the CMOS circuit in which the roles of the source region and of the drain region are replaced by each other, it is desired that the n-channel TFT forming the CMOS circuit forms the LDD regions on both sides of the channel-forming region in such a manner that the LDD regions sandwich the channel-forming region. Further, in the driver circuits, when a CMOS circuit in which it is necessary to suppress the value of the off current as much as possible is used, the n-channel TFT forming the CMOS circuit preferably has an Lov region.

In practice, further, when the device is completed up to the state of FIG. 24B, it is desired to package (seat) the device with a protection film (laminated film, ultraviolet curable resin film etc.) having high air-tightness permitting the gas to escape little or with a light-transmitting sealing member so that the device will not be exposed to the open air. In this case, the interior of the sealing member may be filled with an inert atmosphere or a hygroscopic material (e.g., barium oxide) may be arranged therein to improve the reliability of the OLEDs.

After the air-tightness is enhanced by the treatment such as packaging, the device is completed as the product by attaching a connector (flexible printed circuit: FPC) for connecting the element formed on the substrate or for connecting the terminals drawn from the circuit to the external signal terminals. The device in a state that can be shipped is called display device in this specification.

By following the process shown in this embodiment, the number of photo masks needed in manufacturing a display device can be reduced. As a result, the process is cut short to reduce the manufacture cost and improve the yield. This embodiment can be carried out by freely combining with embodiment 1 or embodiment 4.

The above-described inventions can be implemented onto all of the electronic devices that incorporate such display devices as a display portion. Following can be given as such electronic devices: a personal computer, a video camera, a mobile computer, a goggle type display, a recording medium, a front type projector, a rear type projector, a portable telephone, and a display.

In accordance with the above-described structure, a display device that has the higher reading speed from memory, low signal noise effects, and which can be reduced in size, can be offered by the present invention. Further, since wirings can be simplified and the area of a margin can be eliminated, more size reduction can be realized rather than using a mounted memory.

What is claimed is:

1. A display device, comprising:
a plurality of pixels formed by using a thin film transistor on an insulating surface;
a memory having a plurality of memory cells; and
a drive circuit having a source driver and a gate driver,
wherein serial signal data input externally is output in parallel to the plurality of pixels by using a plurality of wirings through the memory.

2. A display device according to claim 1, wherein the drive circuit has a function for simultaneously inputting to one row or one column of the plurality of pixels in which a plurality of data in the memory cells are arranged in matrix.

3. A display device according to claim 1, wherein the drive circuit has a function for simultaneously inputting to a section of one row or one column of the plurality of pixels, which is divided into a plurality of sections.

4. A display device according to claim 1, wherein the source driver has a latch, a level shifter and a DAC.

5. A display device according to claim 1, wherein the source driver has a level shifter and a DAC.

6. A display device according to claim 1, wherein the source driver has a latch and a DAC.

7. A display device according to claim 1, wherein the source driver has a latch, a level shifter and a DAC, and a plurality of DAC are included in a pixel portion having the plurality of pixels.

8. A display device according to claim 7, wherein the DAC has a polarity inversion function.

9. A display device according to claim 1, wherein the memory has a capacity, which can store digital signals for at least one frame.

10. A display device according to claim 1, wherein the memory is an SRAM.

11. A display device according to claim 1, wherein the memory is a DRAM.

12. A display device according to claim 1, wherein each of the plurality of pixels has a liquid crystal display device.

13. A display device according to claim 1, wherein each of the plurality of pixels has an OLED.

14. A display device according to claim 1, wherein each of the plurality of pixels has an electron source element.

15. A display device according to claim 1, wherein the thin film transistor is formed by using a polycrystal semiconductor thin film.

16. A display device according to claim 1, wherein the thin film transistor is formed by using an amorphous semiconductor thin film.

17. The display device according to claim 1, wherein said display device is selected from the group consisting of a personal computer, a video camera, a mobile computer, a goggle type display, a recording medium, a front type projector, a rear type projector, a portable telephone, and a display.

18. A display device, comprising:
a plurality of pixels formed by using a thin film transistor on an insulating surface;
a memory having a plurality of memory cells;
a drive circuit having a source driver and a gate driver; and
means for simultaneously reading out data stored in the plurality of memory cells as digital signals and for inputting to the plurality of pixels through a plurality of wirings formed on the insulating surface.

19. A display device according to claim 18, wherein the drive circuit has a function for simultaneously inputting to one row or one column of the plurality of pixels in which a plurality of data in the memory cells are arranged in matrix.

20. A display device according to claim 18, wherein the drive circuit has a function for simultaneously inputting to a section of one row or one column of the plurality of pixels, which is divided into a plurality of sections.

21. A display device according to claim 18, wherein the source driver has a latch, a level shifter and a DAC.

22. A display device according to claim 18, wherein the source driver has a level shifter and a DAC.

23. A display device according to claim 18, wherein the source driver has a latch and a DAC.

24. A display device according to claim 18, wherein the source driver has a latch, a level shifter and a DAC, and a plurality of DAC are included in a pixel portion having the plurality of pixels.

25. A display device according to claim 21, wherein the DAC has a polarity inversion function.

26. A display device according to claim 18, wherein the memory has a capacity, which can store digital signals for at least one frame.

27. A display device according to claim 18, wherein the memory is an SRAM.

28. A display device according to claim 18, wherein the memory is a DRAM.

29. A display device according to claim 18, wherein each of the plurality of pixels has a liquid crystal display device.

30. A display device according to claim 18, wherein each of the plurality of pixels has an OLED.

31. A display device according to claim 18, wherein each of the plurality of pixels has an electron source element.

32. A display device according to claim 18, wherein the thin film transistor is formed by using a polycrystal semiconductor thin film.

33. A display device according to claim 18, wherein the thin film transistor is formed by using an amorphous semiconductor thin film.

34. The display device according to claim 18, wherein said display device is selected from the group consisting of a personal computer, a video camera, a mobile computer, a goggle type display, a recording medium, a front type projector, a rear type projector, a portable telephone, and a display.

35. A display device, comprising:
a plurality of pixels formed by using a thin film transistor on an insulating surface;
a memory having a plurality of memory cells; and
a drive circuit having a source driver and a gate driver,
wherein the drive circuit:
simultaneously reads data stored in the plurality of memory cells as digital signals and outputs through a plurality of wirings formed on the insulating surface;
holds the output digital signals; and
inputs the held digital signals to the plurality of pixels simultaneously.

36. A display device according to claim 35, wherein the drive circuit has a function for simultaneously inputting to one row or one column of the plurality of pixels in which a plurality of data in the memory cells are arranged in matrix.

37. A display device according to claim 35, wherein the drive circuit has a function for simultaneously inputting to a section of one row or one column of the plurality of pixels, which is divided into a plurality of sections.

38. A display device according to claim 35, wherein the source driver has a latch, a level shifter and a DAC.

39. A display device according to claim 35, wherein the source driver has a level shifter and a DAC.

40. A display device according to claim 35, wherein the source driver has a latch and a DAC.

43. A display device according to claim 35, wherein the source driver has a latch, a level shifter and a DAC, and a plurality of DAC are included in a pixel portion having the plurality of pixels.

44. A display device according to claim 35, wherein the DAC has a polarity inversion function.

45. A display device according to claim 35, wherein the memory has a capacity, which can store digital signals for at least one frame.

46. A display device according to claim 35, wherein the memory is an SRAM.

47. A display device according to claim 35, wherein the memory is a DRAM.

48. A display device according to claim 35, wherein each of the plurality of pixels has a liquid crystal display device.

49. A display device according to claim 35, wherein each of the plurality of pixels has an OLED.

50. A display device according to claim 35, wherein each of the plurality of pixels has an electron source element.

51. A display device according to claim 35, wherein the thin film transistor is formed by using a polycrystal semiconductor thin film.

52. A display device according to claim 35, wherein the thin film transistor is formed by using an amorphous semiconductor thin film.

53. The display device according to claim 35, wherein said display device is selected from the group consisting of a personal computer, a video camera, a mobile computer, a goggle type display, a recording medium, a front type projector, a rear type projector, a portable telephone, and a display.

54. A display device, comprising:
a plurality of pixels formed by using a thin film transistor on an insulating surface;
a memory having a plurality of memory cells; and
a drive circuit having a source driver and a gate driver,
wherein the drive circuit:
simultaneously reads data stored in the plurality of memory cells as digital signals and outputs through a plurality of wirings formed on the insulating surface;
holds the output digital signals; and
converts the held digital signals to analog signals and inputs to the plurality of pixels simultaneously.

55. A display device according to claim 54, wherein the drive circuit has a function for simultaneously inputting to one row or one column of the plurality of pixels in which a plurality of data in the memory cells are arranged in matrix.

56. A display device according to claim 54, wherein the drive circuit has a function for simultaneously inputting to a section of one row or one column of the plurality of pixels, which is divided into a plurality of sections.

57. A display device according to claim 54, wherein the source driver has a latch, a level shifter and a DAC.

58. A display device according to claim 54, wherein the source driver has a level shifter and a DAC.

59. A display device according to claim 54, wherein the source driver has a latch and a DAC.

60. A display device according to claim 54, wherein the source driver has a latch, a level shifter and a DAC, and a plurality of DAC are included in a pixel portion having the plurality of pixels.

61. A display device according to claim 57, wherein the DAC has a polarity inversion function.

62. A display device according to claim 54, wherein the memory has a capacity, which can store digital signals for at least one frame.

63. A display device according to claim 54, wherein the memory is an SRAM.

64. A display device according to claim 54, wherein the memory is a DRAM.

65. A display device according to claim 54, wherein each of the plurality of pixels has a liquid crystal display device.

66. A display device according to claim 54, wherein each of the plurality of pixels has an OLED.

67. A display device according to claim 54, wherein each of the plurality of pixels has an electron source element.

68. A display device according to claim 54, wherein the thin film transistor is formed by using a polycrystal semiconductor thin film.

69. A display device according to claim 54, wherein the thin film transistor is formed by using an amorphous semiconductor thin film.

70. The display device according to claim 54, wherein said semiconductor device is selected from the group consisting of a personal computer, a video camera, a mobile computer, a goggle type display, a recording medium, a front type projector, a rear type projector, a portable telephone, and a display.

71. A display device comprising:
a CPU formed on the pixel substrate on the pixel substrate.;
a memory having a plurality of memory cells; and
a drive circuit having a source driver and a gate driver,
wherein serial signal data input from said CPU is output in parallel to the plurality of pixels by using a plurality of wirings through said memory.

72. A method of driving a display device including:
a plurality of pixels formed by using a thin film transistor on an insulating surface;
a memory having a plurality of memory cells; and
a drive circuit having a source driver and a gate driver, the method comprising the step of outputting serial data input externally to the plurality of pixels in parallel by using a plurality of wirings through the memory.

73. A method of driving a display device according to claim 72, further comprising the step of:
inputting the data to one row or one column of the plurality of pixels.

74. A method of driving a display device according to claim 72, further comprising the step of:
inputting the data to a section of one row or one column of the plurality of pixels, which is divided into a plurality of sections.

75. A method of driving a display device including:
a plurality of pixels formed by using a thin film transistor on an insulating surface;
a memory having a plurality of memory cells; and
a drive circuit having a source driver and a gate driver, the method comprising the steps of:
reading out data stored in the plurality of memory cells as digital signals and simultaneously inputting to the plurality of pixels.

76. A method of driving a display device according to claim 75, further comprising the step of:
inputting the data to one row or one column of the plurality of pixels.

77. A method of driving a display device according to claim 75, further comprising the step of:
inputting the data to a section of one row or one column of the plurality of pixels, which is divided into a plurality of sections.

78. A method of driving a display device including:
a plurality of pixels formed by using a thin film transistor on an insulating surface;
a memory having a plurality of memory cells; and
a drive circuit having a source driver and a gate driver, the method comprising the steps of:
reading data stored in the plurality of memory cells as digital signals;
holding the output digital signals; and
inputting the held digital signals to the plurality of pixels simultaneously.

79. A method of driving a display device according to claim 78, further comprising the step of:
inputting the data to one row or one column of the plurality of pixels.

80. A method of driving a display device according to claim 78, further comprising the step of:
inputting the data to a section of one row or one column of the plurality of pixels, which is divided into a plurality of sections.

81. A method of driving a display device including:
a plurality of pixels formed by using a thin film transistor on an insulating surface;
a memory having a plurality of memory cells; and
a drive circuit having a source driver and a gate driver, the method comprising the steps of:
reading data stored in the plurality of memory cells as digital signals;
holding the digital signals and converting the digital signals to analog signals; and
inputting them to the plurality of pixels simultaneously.

82. A method of driving a display device according to claim 81, further comprising the step of:
inputting the data to one row or one column of the plurality of pixels.

83. A method of driving a display device according to claim 81, further comprising the step of:
inputting the data to a section of one row or one column of the plurality of pixels, which is divided into a plurality of sections.
